(19) United States
(12) Patent Application Publication
(10) Pub. No.: US 2026/0319613 A1
(43) Pub. Date: Oct. 15, 2026

(54) DISPLAY PANEL, DISPLAY DEVICE, AND METHOD FOR CONTROLLING DISPLAY PANEL

(71) Applicants: Ordos Yuansheng Optoelectronics Co., Ltd., Ordos, Inner Mongolia (CN); BOE Technology Group Co., Ltd., Beijing (CN)

(72) Inventors: Zhenhong XIAO, Beijing (CN); Jingyi XU, Beijing (CN); Jianyun XIE, Beijing (CN); Wei LI, Beijing (CN); Guodong WANG, Beijing (CN); Peirong HUO, Beijing (CN); Aiyu DING, Beijing (CN); Yongqiang ZHANG, Beijing (CN); Peng LIU, Beijing (CN); Xiaofeng YIN, Beijing (CN)

(21) Appl. No.: 18/994,122

(22) PCT Filed: Sep. 13, 2023
(86) PCT No.: PCT/CN2023/118533

§ 371 Date: Jan. 14, 2025

(51) Int. Cl. G06F 3/041; G09G 3/36

(52) U.S. Cl. CPC G06F 3/04164; G09G 3/3677; G09G 2300/0408; G09G 2300/0426; G09G 2310/08

(57) ABSTRACT

Disclosed are a display panel, a display device, and a method for controlling the display panel. The display panel includes a display signal selection circuit, a touch signal selection circuit and a timing selection circuit. The timing selection circuit includes a plurality of timing selection lines, a plurality of first timing switches and a plurality of second timing switches. Each of the timing selection lines is electrically connected to gates of a corresponding plurality of the first timing switches or a corresponding plurality of the second timing switches. The display signal selection circuit and the touch signal selection circuit are both electrically connected to the first and second timing switches of the timing selection circuit. The timing selection circuit is electrically connected to a display data line through the first timing switch, and is electrically connected to a touch signal line through the second timing switch.

### CROSS-REFERENCE OF RELATED APPLICATIONS

The present application is the national phase of International Application No. PCT/CN2023/118533, titled “DISPLAY PANEL, DISPLAY DEVICE, AND METHOD FOR CONTROLLING DISPLAY PANEL”, filed on Sep. 13, 2023, which is incorporated herein by reference in its entirety.

### TECHNICAL FIELD

The present disclosure relates to the technical field of display technologies, and in particular to a display panel, a display device, and a method of controlling the display panel.

### BACKGROUND

In the related art, with the development of display technologies, the range of application of displays is increasing. As the display is applied to various areas of life, user's demands for the display are also increasing, and higher requirements are put forward for the performance of the display, such as color gamut, viewing angle, contrast, response, and display bezel width.

At present, a display signal multiplexer (Display MUX) and a touch signal multiplexer (TP MUX) are provided in the display panel. The display signal multiplexer mainly serves to reduce the number of wirings that electrically connect display data lines of respective pixels in a display area to a driving chip. Similarly, the touch signal multiplexer mainly serves to reduce the number of wirings that electrically connect various touch signal lines in the display area to a driving chip.

However, the simple stacking of the display signal multiplexer and the touch signal multiplexer in the display panel makes the bezel of the display panel wider.

### SUMMARY

In a first aspect according to an embodiment of the present disclosure, there is provided a display panel including a display signal selection circuit, a touch signal selection circuit, and a timing selection circuit;
The timing selection circuit includes timing selection lines, first timing switches, and second timing switches; and each of said timing selection lines is electrically connected to gates of corresponding ones of the first timing switches or gates of corresponding ones of the second timing switches;
The display signal selection circuit and the touch signal selection circuit are both electrically connected to the first timing switches and the second timing switches; and the timing selection circuit is electrically connected to display data lines in the display panel through the first timing switches, and is electrically connected to touch signal lines in the display panel through the second timing switches.

In some embodiments, the touch signal selection circuit includes a touch selector line, touch detection lines, and detection switches; and the display signal selection circuit includes a pixel selector line, display signal lines, and display switches;
The touch selector line includes sub-touch selection lines; each of the sub-touch selection lines is electrically connected to gates of multiple detection switches of the detection switches and is configured to turn on or turn off the multiple detection switches; and the touch detection lines are electrically connected to the timing selection circuit through the detection switches;
The pixel selector line includes sub-pixel selection lines; each of the sub-pixel selection lines is electrically connected to gates of multiple display switches of the display switches and is configured to turn on or turn off the multiple display switches; and the display signal lines are electrically connected to the timing selection circuit through the display switches.

In some embodiments, the touch selector line includes the sub-touch selection lines; each of the sub-touch selection lines is electrically connected to fourth timing switches, and is electrically connected to gates of the multiple detection switches through the fourth timing switches; each of the touch detection lines is electrically connected to sixth timing switches, and is electrically connected to sources of corresponding ones of the detection switches through the sixth timing switches; and gates of the sixth timing switches, gates of the fourth timing switches, and gates of the second timing switches receive the same timing signal;
The pixel selector line includes the sub-pixel selection lines; each of the sub-pixel selection lines is electrically connected to third timing switches, and is electrically connected to gates of the multiple display switches through the third timing switches; each of the display signal lines is electrically connected to fifth timing switches, and is electrically connected to sources of corresponding ones of the display switches through the fifth timing switches; and gates of the fifth timing switches, gates of the third timing switches, and gates of the first timing switches receive the same timing signal;
The detection switches and the display switches are multiplexing switches, and the sub-pixel selection lines and the sub-touch selection lines are electrically connected to gates of the multiplexing switches.

In some embodiments, the touch signal selection circuit further includes a compensation selector line, compensation switches, and a compensation signal line;
The compensation selector line includes compensation selection lines; each of the compensation selection lines is electrically connected to gates of multiple compensation switches of the compensation switches; and the compensation signal line is electrically connected to the timing selection circuit through the compensation switches;
The timing selection circuit includes sub-selection groups, each of which is electrically connected to a respective display data line of the display data lines and a respective touch signal line of the touch signal lines; and a drain of each of the compensation switches and a drain of a corresponding detection switch of the detection switches are electrically connected to a same sub-selection group of the sub-selection groups.

In some embodiments, the touch signal selection circuit further includes a compensation selector line, compensation switches and a compensation signal line;
The compensation selector line includes compensation selection lines; each of the compensation selection lines is electrically connected to fourth timing switches, and is electrically connected to gates of corresponding ones of the compensation switches through the fourth timing switches; the compensation signal line is electrically connected to sixth timing switches, and is electrically connected to sources of the compensation switches through the sixth timing switches; the compensation signal line is electrically connected to the timing selection circuit through the compensation switches; and gates of the sixth timing switches, gates of the fourth timing switches, and gates of the second timing switches receive the same timing signal;
The pixel selector line includes the sub-pixel selection lines; each of the sub-pixel selection lines is electrically connected to third timing switches, and is electrically connected to gates of corresponding ones of the display switches through the third timing switches; the display signal lines are electrically connected to fifth timing switches, and are electrically connected to sources of corresponding ones of the display switches through the fifth timing switches; and gates of the fifth timing switches, gates of the third timing switches, and gates of the first timing switches receive the same timing signal;
The compensation switches and the display switches are multiplexing switches, and the sub-pixel selection lines and the compensation selection lines are electrically connected to gates of the multiplexing switches;
The timing selection circuit includes sub-selection groups, each of which is electrically connected to a respective display data line of the display data lines and a respective touch signal line of the touch signal lines; and a drain of each of the compensation switches and a drain of a corresponding detection switch of the detection switches are electrically connected to a same sub-selection group of the sub-selection groups.

In some embodiments, the display panel further includes touch driving units; the touch driving units are electrically connected to the compensation selector line, the touch selector line and the compensation signal line;
Each of the touch driving units includes at least two sub-touch driving groups, and the at least two sub-touch driving groups are electrically connected to at least two adjacent touch signal lines of the touch signal lines, respectively; each of the at least two sub-touch driving groups includes one of the fourth timing switches, one of the sixth timing switches, one of the detection switches and one of the display switches; and the at least two sub-touch driving groups share a touch detection line of the touch detection lines, which is electrically connected to two of the detection switches;
The at least two sub-touch driving groups are electrically connected to at least two of the sub-touch selection lines respectively, and are electrically connected to at least two of the compensation selection lines respectively.

In some implementations, the display panel further includes display driving units; the display driving units are electrically connected to the pixel selector line; each of the display driving units is electrically connected to one of the display signal lines;
Each of the display driving unit includes at least two sub-display driving groups, each of which includes at least one of the third timing switches and at least one of the fifth timing switches, and one of the display switches; the pixel selector line includes at least two sub-pixel selection lines of the sub-pixel selection lines; the at least two sub-display driving groups are electrically connected to the at least two sub-pixel selection lines respectively;
The at least two sub-pixel selection lines are respectively electrically connected to at least two display switches of the display switches through at least two third timing switches of the third timing switches located in a same display driving unit of the display driving units; the display signal line branches into at least two display signal branches, and the at least two display signal branches are respectively electrically connected to the at least two display switches through at least two fifth timing switches of the fifth timing switches located in the same display driving unit, and are respectively electrically connected to at least two of the display data lines through the at least two display switches.

In some embodiments, the pixel selector line includes two sub-pixel selection lines; and the display driving unit includes two third timing switches of the third timing switches, two fifth timing switches of the fifth timing switches, and two display switches of the display switches;
The two sub-pixel selection lines are respectively electrically connected to the two display switches through the two third timing switches located in the same display driving unit; the display signal line branches into two display signal branches, and the two display signal branches are respectively electrically connected to the two display switches through the two fifth timing switches located in the same display driving unit, and are respectively electrically connected to two of the display data lines after passing through the two display switches.

In some embodiments, the pixel selector line includes three sub-pixel selection lines; and the display driving unit includes three third timing switches of the third timing switches, three fifth timing switches of the fifth timing switches, and three display switches of the display switches;
The three sub-pixel selection lines are respectively electrically connected to the three display switches through the three third timing switches located in the same display driving unit; the display signal line branches into three display signal branches, and the three display signal branches are respectively electrically connected to the three display switches through the three fifth timing switches located in the same display driving unit, and are respectively electrically connected to three of the display data lines after passing through the three display switches.

In some embodiments, the pixel selector line includes four sub-pixel selection lines; and the display driving unit includes four third timing switches of the third timing switches, four fifth timing switches of the fifth timing switches, and four display switches of the display switches;
The four sub-pixel selection lines are respectively electrically connected to the four display switches through the four third timing switches located in the same display driving unit; the display signal line branches into four display signal branches, and the four display signal branches are respectively electrically connected to the four display switches through the four fifth timing switches located in the same display driving unit, and are respectively electrically connected to four of the display data lines after passing through the four display switches.

In some embodiments, the pixel selector line includes five sub-pixel selection lines; and the display driving unit includes five third timing switches of the third timing switches, five fifth timing switches of the fifth timing switches, and five display switches of the display switches;
The five sub-pixel selection lines are respectively electrically connected to the five display switches through the five third timing switches located in the same display driving unit; the display signal line branches into five display signal branches, and the five display signal branches are respectively electrically connected to the five display switches through the five fifth timing switches located in the same display driving unit, and are respectively electrically connected to five of the display data lines after passing through the five display switches.

In some embodiments, the pixel selector line includes six sub-pixel selection lines; and the display driving unit includes six third timing switches of the third timing switches, six fifth timing switches of the fifth timing switches, and six display switches of the display switches;
The six sub-pixel selection lines are respectively electrically connected to the six display switches through the six third timing switches located in the same display driving unit; the display signal line branches into six display signal branches, and the six display signal branches are respectively electrically connected to the six display switches through the six fifth timing switches located in the same display driving unit, and are respectively electrically connected to six of the display data lines through the six display switches.
In some embodiments, the touch signal selection circuit further includes precision switches;

Each of the detection switches is connected in parallel with at least one of the precision switches; a gate of each precision switch of the precision switches and a gate of a corresponding detection switch of the detection switches that is connected in parallel with the each precision switch are electrically connected to a same sub-touch selection line of the sub-touch selection lines.

In some embodiments, the display panel further includes a liquid crystal structure and a supplemental power supply;
The liquid crystal structure includes common electrodes, pixel electrodes, and a liquid crystal layer; the common electrodes and the pixel electrodes are at the same side of the liquid crystal layer; and the pixel electrodes are electrically connected to the display data lines, and the common electrodes are electrically connected to the touch signal lines;
The supplemental power supply is electrically connected to the common electrodes and is configured to supply a supplemental voltage to the common electrodes during a period in which the display panel is in a display mode.

In some embodiments, the supplemental power supply includes a first supplemental power supply and a second supplemental power supply; and the first supplemental power supply and the second supplemental power supply are located at two sides of the liquid crystal structure respectively;
A plurality of first sub-power supplies are provided in the first supplemental power supply, and a plurality of second sub-power supplies are provided in the second supplemental power supply; and each of the first sub-power supplies is correspondingly electrically connected to two of the second sub-power supplies and simultaneously electrically connected to two of the common electrodes.

In some embodiments, the display panel further includes a driving chip;
The driving chip is configured to transmit at least a timing signal for driving a gate driving unit; and gates of the first timing switches and the second timing switches are configured to receive the timing signal.

In a second aspect according to an embodiment of the present disclosure, there is provided a display device including any one of the display panels described above.

In a third aspect according to an embodiment of the present disclosure, there is provided a method for controlling the display panel as described above, and the method includes:
When the display panel is in a display mode, the first timing switches are turned on and the second timing switches are turned off, according to timing signals transmitted by the timing selection lines; display signals transmitted by the display signal selection circuit are transmitted to the display data lines through the timing selection circuit;
When the display panel is in a touch mode, the first timing switches are turned off and the second timing switches are turned on, according to the timing signals transmitted by the timing selection lines; touch signals transmitted by the touch signal selection circuit are transmitted to the touch signal lines through the timing selection circuit.

In some embodiments, the touch signal selection circuit includes a touch selector line, touch detection lines, and detection switches; and the display signal selection circuit includes a pixel selector line, display signal lines, and display switches;
The touch selector line includes sub-touch selection lines; each of the sub-touch selection lines is electrically connected to gates of multiple detection switches of the detection switches and is configured to turn on or turn off the multiple detection switches; the touch detection lines are electrically connected to the timing selection circuit through the detection switches; and the touch detection lines are electrically connected to the timing selection circuit through the detection switches when the detection switches are turned on;
The pixel selector line includes sub-pixel selection lines; each of the sub-pixel selection lines is electrically connected to gates of multiple display switches of the display switches and is configured to turn on or turn off the multiple display switches; and the display signal lines are electrically connected to the timing selection circuit through the display switches when the display switches are turned on.

In some embodiments, the touch selector line includes the sub-touch selection lines; each of the sub-touch selection lines is electrically connected to fourth timing switches, is electrically connected to gates of the multiple detection switches through the fourth timing switches, and is configured to turn on or turn off the multiple detection switches when the fourth timing switches are turned on; each of the touch detection lines is electrically connected to sixth timing switches, and is electrically connected to sources of corresponding ones of the detection switches through the sixth timing switches; and gates of the sixth timing switches, gates of the fourth timing switches, and gates of the second timing switches receive the same timing signal;
The pixel selector line includes the sub-pixel selection lines; each of the sub-pixel selection lines is electrically connected to third timing switches, is electrically connected to gates of the multiple display switches through the plurality of third timing switches, and is configured to turn on or turn off the multiple display switches when the third timing switches are turned on; each of the display signal lines is electrically connected to fifth timing switches, and is electrically connected to sources of corresponding ones of the display switches through the fifth timing switches; and gates of the fifth timing switches, gates of the third timing switches, and gates of the first timing switches receive the same timing signal;
The detection switches and the display switches are multiplexing switches, and the sub-pixel selection lines and the sub-touch selection lines are electrically connected to gates of the multiplexing switches, the sub-pixel selection lines are configured to turn on or turn off the multiplexing switches when the third timing switches and the fifth timing switches are turned on, and the sub-touch selection lines are configured to turn on or turn off the multiplexing switches when the fourth timing switches and the sixth timing switches are turned on.

In some embodiments, the touch signal selection circuit further includes a compensation selector line, compensation switches, and a compensation signal line;
The compensation selector line includes compensation selection lines; each of the compensation selection lines is electrically connected to gates of multiple compensation switches of the compensation switches and is configured to turn on or turn off the multiple compensation switches; the compensation signal line is electrically connected to the timing selection circuit through the compensation switches;
The timing selection circuit includes sub-selection groups, each of which is electrically connected to a respective display data line of the display data lines and a respective touch signal line of the touch signal lines; a drain of each of the compensation switches and a drain of a corresponding detection switch of the detection switches are electrically connected to a same sub-selection group of the sub-selection groups; the compensation switch and the detection switch that are correspondingly electrically connected to the same sub-selection group are alternately turned on during a period in which the display panel is in the touch mode.

In some embodiments, the touch signal selection circuit further includes a compensation selector line, compensation switches, and a compensation signal line;
The compensation selector line includes compensation selection lines; each of the compensation selection lines is electrically connected to fourth timing switches, is electrically connected to gates of corresponding ones of the compensation switches through the fourth timing switches, and is configured to turn on or turn off the compensation switches when the fourth timing switches are turned on; the compensation signal line is electrically connected to sixth timing switches, and is electrically connected to sources of the compensation switches through the sixth timing switches; the compensation signal line is electrically connected to the timing selection circuit through the compensation switches; and gates of the sixth timing switches, gates of the fourth timing switches, and gates of the second timing switches receive the same timing signal;
The pixel selector line includes the sub-pixel selection lines; each of the sub-pixel selection lines is electrically connected to third timing switches, is electrically connected to gates of the multiple display switches through the third timing switches, and is configured to turn on or turn off the multiple display switches when the third timing switches are turned on; the display signal lines are electrically connected to fifth timing switches, and are electrically connected to sources of corresponding ones of the display switches through the fifth timing switches; and gates of the fifth timing switches, gates of the third timing switches, and gates of the first timing switches receive the same timing signal;
The compensation switches and the display switches are multiplexing switches, and the sub-pixel selection lines and the compensation selection lines are electrically connected to gates of the multiplexing switches; the sub-pixel selection lines are configured to turn on or turn off the multiplexing switches when the third timing switches and the fifth timing switches are turned on, and the compensation selection lines are configured to turn on or turn off the multiplexing switches when the fourth timing switches and the sixth timing switches are turned on;
The timing selection circuit includes sub-selection groups, each of which is electrically connected to a respective display data line of the display data lines and a respective touch signal line of the touch signal lines; a drain of each of the compensation switches and a drain of a corresponding detection switch of the detection switches are electrically connected to a same sub-selection group of the sub-selection groups; the compensation switch and the detection switch that are correspondingly electrically connected to the same sub-selection group are alternately turned on during a period in which the display panel is in the touch mode.

In some embodiments, the display panel further includes touch driving units; the touch driving units are electrically connected to the compensation selector line, the touch selector line and the compensation signal line;
Each of the touch driving units includes at least two sub-touch driving groups, and the at least two sub-touch driving groups are electrically connected to at least two adjacent touch signal lines of the touch signal lines, respectively; each of the at least two sub-touch driving groups includes one of the fourth timing switches, one of the sixth timing switches, one of the detection switches and one of the display switches; and the at least two sub-touch driving groups included in the same touch driving unit share a touch detection line of the touch detection lines, which is electrically connected to two of the detection switches;
The at least two sub-touch driving groups of each of the touch driving units are electrically connected to at least two of the sub-touch selection lines respectively, and are electrically connected to at least two of the compensation selection lines respectively;
When the display panel is in the touch mode, during a first period, one of the at least two sub-touch driving groups is electrically connected to the touch detection line, and another of the at least two sub-touch driving groups is electrically connected to the compensation signal line; and during a second period, objects, to which the two sub-touch driving groups are electrically connected, are interchanged.

In some embodiments, the display panel further includes display driving units; the display driving units are electrically connected to the pixel selector line; each of the display driving units is electrically connected to one of the display signal lines;
Each of the display driving units includes at least two sub-display driving groups, each of which includes at least one of the third timing switches and at least one of the fifth timing switches, and one of the display switches; the pixel selector line includes at least two sub-pixel selection lines; the at least two sub-display driving groups of each of the display driving units are respectively electrically connected to the at least two sub-pixel selection lines;
When the display panel is in the display mode, the at least two sub-pixel selection lines are respectively electrically connected to at least two of the display switches through at least two of the third timing switches located in the same display driving unit; the display signal line branches into at least two display signal branches, and the at least two display signal branches are respectively electrically connected to the at least two display switches through at least two of the fifth timing switches located in the same display driving unit, and are respectively electrically connected to at least two of the display data lines through the at least two display switches.

According to the embodiment of the present disclosure, by introducing the first timing switch and the second timing switch and the corresponding timing selection lines, the corresponding signals can be transmitted by the plurality of timing selection lines for different modes of the display panel to control the turn-on or turn-off operations of the first timing switch and the second timing switch, so as to realize that in the different modes of the display panel, the touch signal selection circuit is electrically connected to the touch signal line, or the display signal selection circuit is electrically connected to the display data line. Therefore, the integrated design of the display signal selection circuit and the touch signal selection circuit can be realized, and the problem of signal short-circuit in the line formed after integration is avoided by the first timing switch and the second timing switch. Furthermore, the width of the bezel of the display panel occupied by the display signal selection circuit and the touch signal selection circuit can be reduced without affecting the operation of the display panel.

It should be understood that both the foregoing general description and the following detailed description are merely exemplary and explanatory, and should not be construed to limit the disclosure.

### BRIEF DESCRIPTION OF DRAWINGS

The accompanying drawings, which are incorporated into and constitute a part of the specification, illustrate embodiments consistent with the present disclosure and, together with the description, serve to explain the principles of the present disclosure.

FIG. 1 is a schematic structural diagram of a display panel in the related art.

FIG. 2 is a schematic structural diagram of a display panel according to an embodiment of the present disclosure.

FIG. 3 is a schematic structural diagram of a signal selection circuit 12 of FIG. 2 according to an embodiment of the present disclosure.

FIG. 4 is a timing diagram according to an embodiment of the present disclosure.

FIG. 5 is a schematic structural diagram of another signal selection circuit according to an embodiment of the present disclosure.

FIG. 6 is a schematic structural diagram of another signal selection circuit according to an embodiment of the present disclosure.

FIG. 7 is a physical diagram of a structure shown in FIG. 6 according to an embodiment of the present disclosure.

FIG. 8 is a schematic structural diagram of another signal selection circuit according to an embodiment of the present disclosure.

FIG. 9 is a physical diagram of a structure shown in FIG. 8 according to an embodiment of the present disclosure.

FIG. 10 is a diagram showing another configuration division of the signal selection circuit of FIG. 8 according to an embodiment of the present disclosure.

FIG. 11 is a diagram showing another configuration division of the signal selection circuit of FIG. 8 according to an embodiment of the present disclosure.

FIG. 12 is a schematic structural diagram of another signal selection circuit according to an embodiment of the present disclosure.

FIG. 13 is a physical diagram of a structure shown in FIG. 12 according to an embodiment of the present disclosure.

FIG. 14 is a schematic structural diagram of another signal selection circuit according to an embodiment of the present disclosure.

FIG. 15 is a physical diagram of a structure shown in FIG. 14 according to an embodiment of the present disclosure.

FIG. 16 is a schematic structural diagram of another signal selection circuit according to an embodiment of the present disclosure.

FIG. 17 is a physical diagram of a structure shown in FIG. 16 according to an embodiment of the present disclosure.

FIG. 18 is a schematic structural diagram of another signal selection circuit according to an embodiment of the present disclosure.

FIG. 19 is a physical diagram of a structure shown in FIG. 18 according to an embodiment of the present disclosure.

FIG. 20 is a schematic structural diagram of another signal selection circuit according to an embodiment of the present disclosure.

FIG. 21 is a physical diagram of a structure shown in FIG. 21 according to an embodiment of the present disclosure.

FIG. 22 is a schematic structural diagram of another signal selection circuit according to an embodiment of the present disclosure.

FIG. 23 is a physical diagram of a structure shown in FIG. 22 according to an embodiment of the present disclosure.

FIG. 24 is a schematic diagram showing electrical connection between an upper electrode to a supplemental power supply according to an embodiment of the present disclosure.

FIG. 25 is a schematic wiring diagram showing electrical connection between a first sub-power supply, a second sub-power supply, and an upper electrode according to an embodiment of the present disclosure.

FIG. 26 is a timing diagram corresponding to FIG. 25 according to an embodiment of the present disclosure.

### DETAILED DESCRIPTION

Exemplary embodiments will be described in detail herein, examples of which are illustrated in the accompanying drawings. When the following description refers to the drawings, the same numbers in different drawings indicate the same or similar elements, unless otherwise indicated. The implementations described in the following exemplary embodiments do not represent all embodiments consistent with the present disclosure. Rather, they are merely examples of devices and methods consistent with some aspects of the disclosure as detailed in the appended claims.

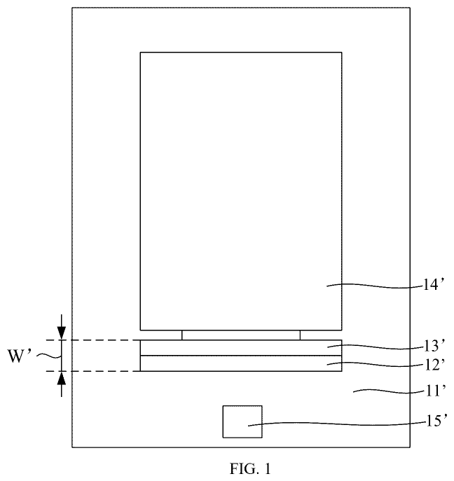

In the related display technology, reference is made to a display panel shown in FIG. 1, which includes a substrate 11′, a display signal selection circuit 12′, a touch signal selection circuit 13′, and a light emitting structure 14′. The display signal selection circuit 12′, the touch signal selection circuit 13′, and the light emitting structure 14′ are all located on the substrate 11′, and each of the display signal selection circuit 12′ and the touch signal selection circuit 13′ is electrically connected to the light emitting structure 14′ through wirings. The display signal selection circuit 12′ and the touch signal selection circuit 13′ are also electrically connected to the driving chip 15′ through wirings, and the signals transmitted from the driving chip 15′ are transmitted to a display data line and a touch signal line in the light emitting structure 14′ through the display signal selection circuit 12′ and the touch signal selection circuit 13′, and then transmitted to a pixel electrode through the display data line and to a touch electrode through the touch signal line.

Since the display signal selection circuit 12′ and the touch signal selection circuit 13′ are simply and compactly arranged on the substrate 11′, there is no structural correlation between the display signal selection circuit 12′ and the touch signal selection circuit 13′. Therefore, a width of the bezel of the display panel, which is occupied by the display signal selection circuit 12′ and the touch signal selection circuit 13′, is wider, that is, a width W′ shown in FIG. 1 is wider.

If the display signal selection circuit 12′ and the touch signal selection circuit 13′ are simply integrated, a signal short-circuit problem will occur between the display signal selection circuit 12′ and the touch signal selection circuit 13′, that is, signals transmitted by two types of lines will conflict in some common lines after integration. Therefore, when the display signal selection circuit 12′ and the touch signal selection circuit 13′ are integrated, it is an urgent problem to be addressed to reduce the area of the bezel of the display panel occupied by the display signal selection circuit 12′ and the touch signal selection circuit 13′ through integrating and linking them while avoiding the signal short-circuit.

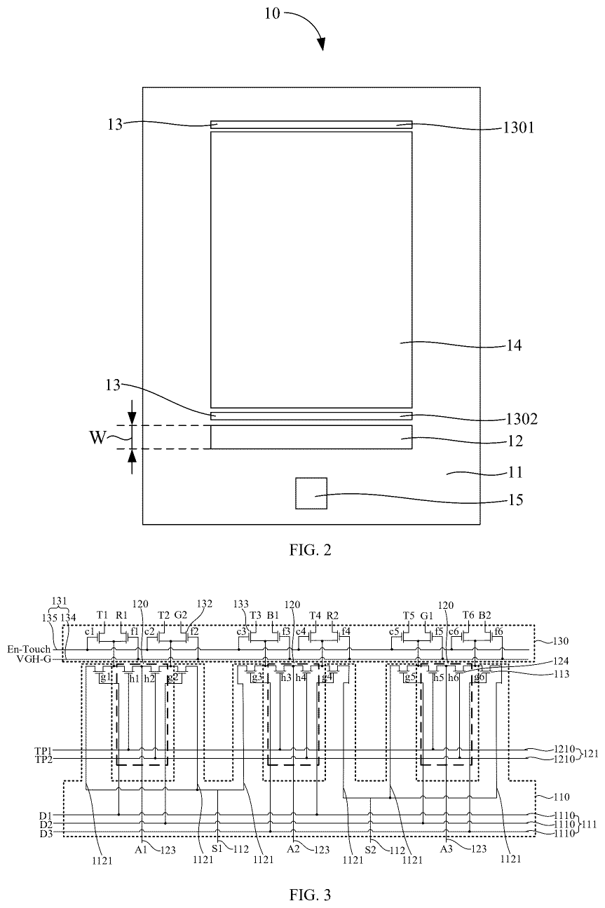

An embodiment of the present disclosure provides a display panel 10. FIG. 2 is a schematic structural diagram of the display panel 10. FIG. 3 is a schematic structural diagram of a signal selection circuit 12 of FIG. 2. As shown in FIGS. 2 and 3, the display panel 10 includes a display signal selection circuit 110, a touch signal selection circuit 120, and a timing selection circuit 130.

The timing selection circuit 130 includes a plurality of timing selection lines 131, a plurality of first timing switches 132, and a plurality of second timing switches 133. Each of the timing selection lines 131 is electrically connected to gates of a corresponding plurality of first timing switches 132 or a corresponding plurality of second timing switches 133.

Specifically, FIG. 3 shows that the different timing selection lines 131 are electrically connected to the gates of the corresponding first timing switches 132 or the corresponding second timing switches 133. That is, the timing selection lines 131 shown in FIG. 3 include a first timing selection line 134 and a second timing selection line 135, the first timing selection line 134 is correspondingly electrically connected to gates of the first timing switches 132, and the second timing selection line 135 is correspondingly electrically connected to gates of the second timing switches 133.

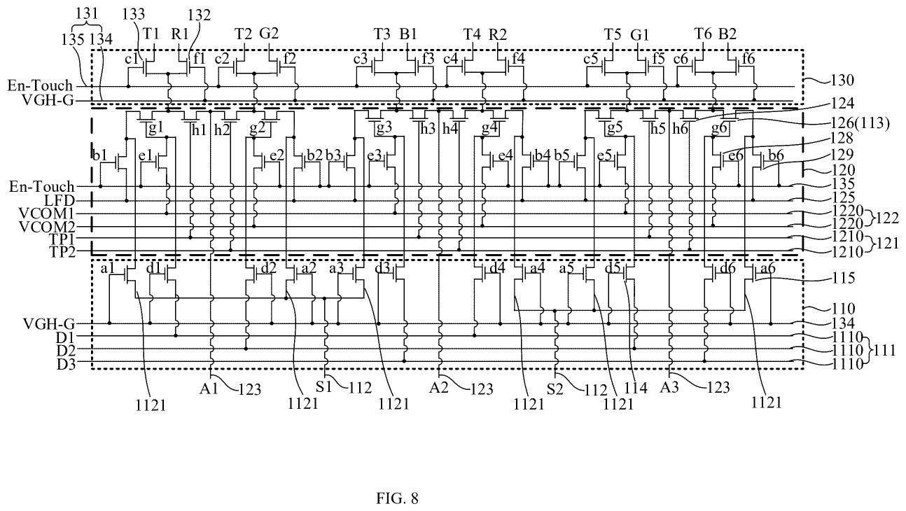

Here, as shown in FIG. 3, and referring to FIG. 8 in which the structural schematic diagram of another signal selection circuit 12 is shown, the first timing switches 132 include switches f1/f2/f3/f4/f5/f6, and the second timing switches 133 include switches c1/c2/c3/c4/c5/c6. The plurality of timing selection lines 131 are electrically connected to the gates of the first timing switches 132 and the second timing switches 133, so as to turn on or turn off the first timing switches 132 and the second timing switches 133.

Both the display signal selection circuit 110 and the touch signal selection circuit 120 are electrically connected to the first timing switches 132 and the second timing switches 133 of the timing selection circuit 130. The timing selection circuit 130 is electrically connected to display data lines through the first timing switches 132, and is electrically connected to touch signal lines through the second timing switches 133.

Specifically, the display data lines are configured to transmit a display signal transmitted by the signal selection circuit 12 to a touch display structure 14 of the display panel 10, so as to implement a display function of the display panel 10, and the display data lines may include display data lines R1/G1/B1/R2/G2/B2 as shown in FIG. 3.

The touch signal lines are configured to transmit a touch signal transmitted by the signal selection circuit 12 to the touch display structure 14 of the display panel 10, so as to implement a touch function of the display panel 10, and the touch signal lines may include touch signal lines T1/T2/T3/T4/T5/T6 as shown in FIG. 3.

The display signal selection circuit 110 and the touch signal selection circuit 120 may be electrically connected to the same wiring in the timing selection circuit 130, and the wiring may extend to obtain two branches and then be electrically connected to the first timing switch 132 and the second timing switch 133 in the timing selection circuit 130 respectively through the two branches.

When the display panel 10 is in a display mode 101, based on the timing signals transmitted by the timing selection lines 131, the first timing switches 132 are turned on and the second timing switches 133 are turned off. The display signal transmitted by the display signal selection circuit 110 is transmitted to the display data line through the timing selection circuit 130.

That is, the switches f1/f2/f3/f4/f5/f6 are turned on, and the switches c1/c2/c3/c4/c5/c6 are turned off, so that an electrical path from the display signal selection circuit 110 to the display data line can be formed to transmit the display signal to the display data line.

When the display panel 10 is in a touch mode 102, based on the timing signals transmitted by the timing selection lines 131, the first timing switches 132 are turned off and the second timing switches 133 are turned on. The touch signal transmitted by the touch signal selection circuit 120 is transmitted to the touch signal line through the timing selection circuit 130.

That is, the switches f1/f2/f3/f4/f5/f6 are turned off, and the switches c1/c2/c3/c4/c5/c6 are turned on, so that an electrical path from the touch signal selection circuit 120 to the touch signal line can be formed to transmit the touch signal to the touch signal line.

By introducing the first timing switches 132 and the second timing switches 133, and the corresponding timing selection circuit 130, the corresponding signals can be transmitted through the plurality of timing selection lines 131 for the different modes of the display panel 10, to control the turn-on or turn-off operations of the first timing switches 132 and the second timing switches 133, so that in the different modes of the display panel, the touch signal selection circuit 120 is electrically connected to the touch signal line or the display signal selection circuit 110 is electrically connected to the display data line. Therefore, the integrated design of the display signal selection circuit 110 and the touch signal selection circuit 120 can be realized, and the problem of signal short-circuit in the line formed after integration is avoided by the first timing switches 132 and the second timing switches 133. Furthermore, the width W of the bezel of the display panel 10 occupied by the display signal selection circuit 110 and the touch signal selection circuit 120, that is, the width W shown in FIG. 2, can be reduced without affecting the operation of the display panel 10.

It should be noted that the areas of the display signal selection circuit 110, the touch signal selection circuit 120, and the timing selection circuit 130 shown in FIG. 3 are divided only for the purpose of showing the wirings more clearly. In fact, in the circuit diagram, since an integrated design is applied to the signal selection circuit 12, there are overlapping portions between various wirings. For example, the display signal selection circuit 110 has some wirings which need to pass through the area of the touch signal selection circuit 120, and the touch signal selection circuit 120 has some wirings which need to pass through the area of display signal selection circuit 110. These overlapping wirings do not affect the area division of the display signal selection circuit 110, the touch signal selection circuit 120, and the timing selection circuit 130. The signal selection circuit 12 shown in the other drawings may also be described with reference to the description herein.

In some embodiments, as shown in FIG. 2, the display panel 10 includes a substrate 11, the signal selection circuit 12, the touch display structure 14, and a driving chip 15.

The signal selection circuit 12, the touch display structure 14, and the driving chip 15 are all located at the same side of the substrate 11. The driving chip 15 is electrically connected to the signal selection circuit 12 through the wiring, the signal selection circuit 12 is electrically connected to the display data line and the touch signal line, and the display data line and the touch signal line are correspondingly electrically connected to the pixel electrode and the touch electrode in the touch display structure 14, respectively. The touch signal or the display signal transmitted by the driving chip 15 is transmitted to the touch signal line or the display data line through the signal selection circuit 12.

The touch display structure 14 is a light emitting area of the display panel 10. The display data lines and the gate data lines together constitute a driver array for driving the touch display structure 14 to emit light. After receiving the display signals transmitted by the display data lines, the touch display structure 14 performs different light emitting functions according to the display signals. When the liquid crystal display principle is applied, the display signals are applied to electrodes at both sides of a liquid crystal layer in the touch display structure 14, different electric fields are formed to control deflection angles of liquid crystal particles in various parts of the liquid crystal layer, and the light emitted from the backlight structure of the display panel 10 is transmitted through the liquid crystal particles with different deflection angles, so as to realize different light emitting states. When the self-luminescent material display principle is applied, the display signals are applied to different anodes in the touch display structure 14, each anode is electrically connected to a respective self-luminescent material, and the self-luminescent material receiving the voltage of the display signal releases energy through forming excitons by recombining holes and electrons inside the self-luminescent material, thereby realizing different light-emitting states.

The surface of the touch display structure 14 is further provided with an array of touch electrodes. The touch electrode may include a self-capacitive touch electrode and a mutual-capacitive touch electrode according to different sensing principles. For the mutual-capacitive touch electrodes, the touch electrodes of each row or column are electrically connected to the same touch signal line. For the self-capacitive touch electrodes, each touch electrode or every few touch electrodes are electrically connected to the same touch signal line.

For the mutual-capacitive touch electrode, the touch signal line serves to transmit the touch signal. For the self-capacitive touch electrode, the touch signal line serves to transmit the touch signal or a compensation signal, and signals transmitted to adjacent touch electrodes by the touch signal line during the same period are a touch signal and a compensation signal, respectively. The touch electrode receiving the touch signal is configured to generate a touch indication signal when the contact of a touch object (for example, a hand and a stylus) is sensed, and then the touch indication signal is transmitted to the driving chip 15 through the touch signal line and the signal selection circuit 12. At the same time, the touch electrode adjacent to the touch electrode receiving the touch signal receives the compensation signal, which serves to avoid the generation of a coupling capacitance, which affects the recognition of the touch object by the touch electrode receiving the touch signal, between the touch electrode receiving the touch signal and the adjacent touch electrode.

The substrate 11 may be a flexible substrate, and material of the substrate 11 may include, but is not limited to, polyimide (PI) and glass. Currently, the material of the substrate 11 may be mainly glass.

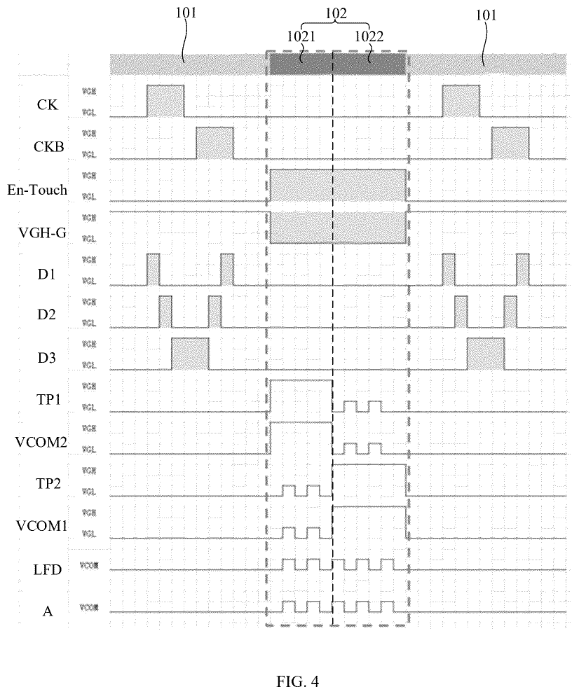

In some embodiments, reference is made to FIG. 3 in which a schematic structural diagram of the signal selection circuit 12 is shown, and FIG. 4 in which a timing diagram is shown. The touch signal selection circuit 120 includes a touch selector line 121, a plurality of touch detection lines 123, and a plurality of detection switches 124. The display signal selection circuit 110 includes a pixel selector line 111, a plurality of display signal lines 112, and a plurality of display switches 113.

The touch selector line 121 includes a plurality of sub-touch selection lines 1210. Each of the sub-touch selection lines 1210 is electrically connected to gates of a plurality of detection switches 124 and is configured to turn on or turn off the detection switches 124. The touch detection line 123 is electrically connected to the timing selection circuit 130 through a corresponding detection switch 124. The touch detection line 123 is electrically connected to the timing selection circuit 130 through the corresponding detection switch 124 when the detection switch 124 is turned on.

Specifically, the detection switches 124 include switches h1/h2/h3/h4/h5/h6 in FIG. 3. The touch selector line 121 includes sub-touch selection lines 1210 of FIG. 3 for transmitting signals TP1/TP2. The touch detection lines 123 include lines of FIG. 3 for transmitting touch signals a1/a2/a3.

The pixel selector line 111 includes a plurality of sub-pixel selection lines 1110. Each of the sub-pixel selection lines 1110 is electrically connected to gates of a plurality of display switches 113 and is configured to turn on or turn off the display switches 113. The display signal line 112 is electrically connected to the timing selection circuit 130 through a corresponding display switch 113. The display signal line 112 is electrically connected to the timing selection circuit 130 through the corresponding display switch 113 when the display switch 113 is turned on.

Specifically, the display switches 113 include switches g1/g2/g3/g4/g5/g6 in FIG. 3. The pixel selector line 111 includes sub-pixel selection lines 1110 for transmitting signals D1/D2/D3 in FIG. 3. The display signal lines 112 include lines of FIG. 3 for transmitting display signals S1/S2.

Taking the partial structure shown in FIG. 3 as an example, when the display panel 10 is in the display mode 101, a signal VGH-G transmitted by the first timing selection line 134 is set to a high level, and a signal En-Touch transmitted by the second timing selection line 135 is set to a low level. Therefore, the switches f1/f2/f3 are turned on, the switches c1/c2/c3 are turned off, and the display signal selection circuit 110 is electrically connected to the timing selection circuit 130. The signals D1/D2/D3 transmitted by the plurality of sub-pixel selection lines 1110 included in the pixel selector line 111 are set to the high level in turn. Based on the signals D1/D2/D3 at the high level, the corresponding display switches 113 can be controlled to be turned on in sequence, that is, the switches g1/g2/g3 are turned on in sequence, so that the display signal S1 transmitted by the display signal line 112 passes through the switches g1/g2/g3 and then is transmitted to the display data lines R1/G2/B1, during different periods.

When the display panel is in the touch mode 102, the signal VGH-G transmitted by the first timing selection line 134 is set to a low level, and the signal En-Touch transmitted by the second timing selection line 135 is set to a high level. Therefore, the switches f1/f2 are turned off, and the switches c1/c2 are turned on, and the touch signal selection circuit 120 is electrically connected to the timing selection circuit 130. The signals TP1/TP2 transmitted by the plurality of sub-touch selection lines 1210 included in the touch selector line 121 are set to the high level in turn. Based on the signal TP1/TP2 at the high level, and the corresponding detection switches 124 can be controlled to be turned on in sequence, that is, the switches h1/h2 are turned on in sequence, so that the touch signal A1 transmitted by the touch detection line 123 passes through the switches h1/h2 and then is transmitted to the touch signal lines T1/T2, during different periods.

With the above arrangement, the integrated design of the display signal selection circuit 110 and the touch signal selection circuit 120 can be realized concretely, and the problem of signal short-circuit in the line formed after integration is avoided by the timing selection circuit 130, so that the width W of the bezel of the display panel 10 occupied by the display signal selection circuit 110 and the touch signal selection circuit 120, that is, the width W shown in FIG. 2, can be reduced without affecting the operation of the display panel 10.

In some embodiments, FIG. 5 illustrates a schematic structural diagram of another signal selection circuit 12. As shown in FIG. 5 and with reference to the timing diagram shown in FIG. 4, the touch selector line 121 includes a plurality of sub-touch selection lines 1210. Each of the sub-touch selection lines 1210 is electrically connected to a plurality of fourth timing switches 128, is electrically connected to gates of a corresponding plurality of detection switches 124 through the plurality of fourth timing switches 128, and is configured to control the turn-on and turn-off operations of the detection switches 124 when the fourth timing switches 128 are turned on. The touch detection line 123 is electrically connected to a plurality of sixth timing switches 129 and electrically connected to sources of a corresponding plurality of detection switches 124 through the plurality of sixth timing switches 129. The gates of the sixth timing switches 129, the fourth timing switches 128, and the second timing switches 133 receive the same timing signal.

Specifically, the fourth timing switches 128 include switches e1/e2/e3/e4. The sixth timing switches 129 include switches b1/b2/b3/b4. The gates of the sixth timing switches 129, the fourth timing switches 128, and the second timing switches 133 may each receive a signal En-Touch.

The pixel selector line 111 includes a plurality of sub-pixel selection lines 1110. Each of the sub-pixel selection lines 1110 is electrically connected to a plurality of third timing switches 114, and then is electrically connected to the gates of the corresponding plurality of display switches 113 after passing through the plurality of third timing switches 114, so as to turn on or turn off the display switches 113 when the third timing switches 114 are turned on. The display signal lines 112 are electrically connected to a plurality of fifth timing switches 115, and then are electrically connected to sources of the corresponding plurality of display switches 113 after passing through the plurality of fifth timing switches 115. The gates of the fifth timing switches 115, the third timing switches 114, and the first timing switches 132 receive the same timing signal.

Specifically, the third timing switches 114 include switches d1/d2/d3/d4. The fifth timing switches 115 include switches a1/a2/a3/a4. The gates of the fifth timing switches 115, the third timing switches 114, and the first timing switches 132 may each receive a signal VGH-G.

The detection switches 124 and the display switches 113 are multiplexing switches, and the sub-pixel selection lines 1110 and the sub-touch selection lines 1210 are electrically connected to the gates of the multiplexing switches.

Taking the partial structure shown in FIG. 5 as an example, when the display panel 10 is in the display mode 101, the signal VGH-G transmitted by the first timing selection line 134 is set to a high level, and the signal En-Touch transmitted by the second timing selection line 135 is set to a low level. Accordingly, the switches f1/f2, the switches d1/d2, and the switches a1/a2 are turned on, and the switches c1/c2, the switches e1/e2, and the switches b1/b2 are turned off, so that the gates of the switches h1/h2 are electrically connected to the corresponding sub-pixel selection lines 1110, and the display signal line 112 is electrically connected to the sources of the switches h1/h2. The signals D1/D2 transmitted by the plurality of sub-pixel selection lines 1110 included in the pixel selector line 111 are set to a high level in turn. When the signals D1/D2 are set to the high level in turn, the corresponding switches h1/h2 can be controlled to be turned on in sequence so that the display signal S1 transmitted by the display signal line 112 passes through the switches h1/h2 and then is transmitted to the display data lines R1/B1, during different periods.

When the display panel is in the touch mode 102, the signal VGH-G transmitted by the first timing selection line 134 is set to a low level, and the signal En-Touch transmitted by the second timing selection line 135 is set to a high level. Accordingly, the switches f1/f2, the switches d1/d2, and the switches a1/a2 are turned off, and the switches c1/c2, the switches e1/e2, and the switches b1/b2 are turned on, so that the gates of the switches h1/h2 are electrically connected to the corresponding sub-touch selection lines 1210, and the touch detection line 123 is electrically connected to the sources of the switches h 1/h2. The signals TP1/TP2 transmitted by the plurality of sub-touch selection lines 1210 included in the touch selector line 121 are set to a high level in turn. When the signals TP1/TP2 are set to the high level in turn, the corresponding switches h1/h2 can be controlled to be turned on in turn so that the touch signal A1 transmitted by the touch detection line 123 passes through the switches h1/h2 and then is transmitted to the touch signal lines T1/T2, during different periods.

With the above arrangement, that is, the combination of the first timing switch 132 and the display signal selection circuit 110 and the combination of the second timing switch 133 and the touch signal selection circuit 120, the detection switch 124 and the display switch 113 can be integrated as a multiplexing switch, so that the integrated design of the display signal selection circuit 110 and the touch signal selection circuit 120 can be further realized, and the problem of signal short-circuit in the line formed after the integration can be avoided by the timing selection circuit 130. Furthermore, the width W of the bezel of the display panel 10 occupied by the display signal selection circuit 110 and the touch signal selection circuit 120, that is, the width W shown in FIG. 2, can be reduced without affecting the operation of the display panel 10.

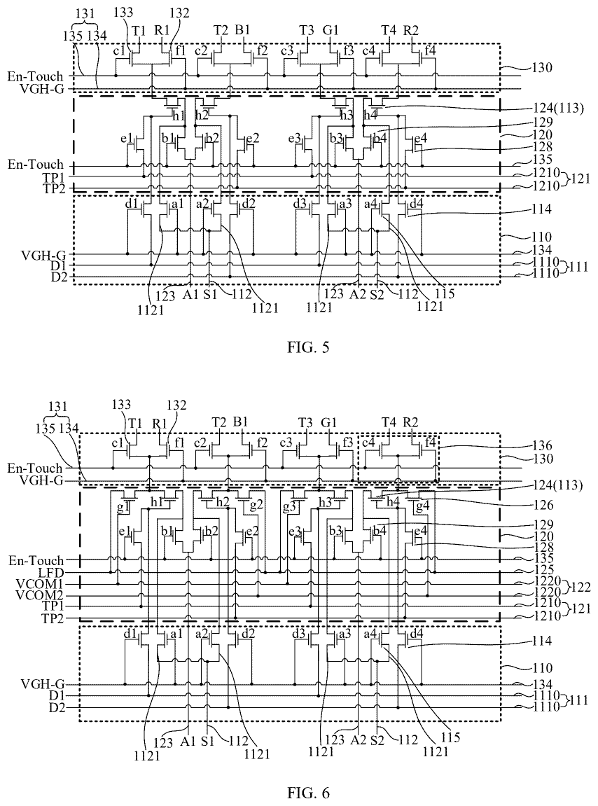

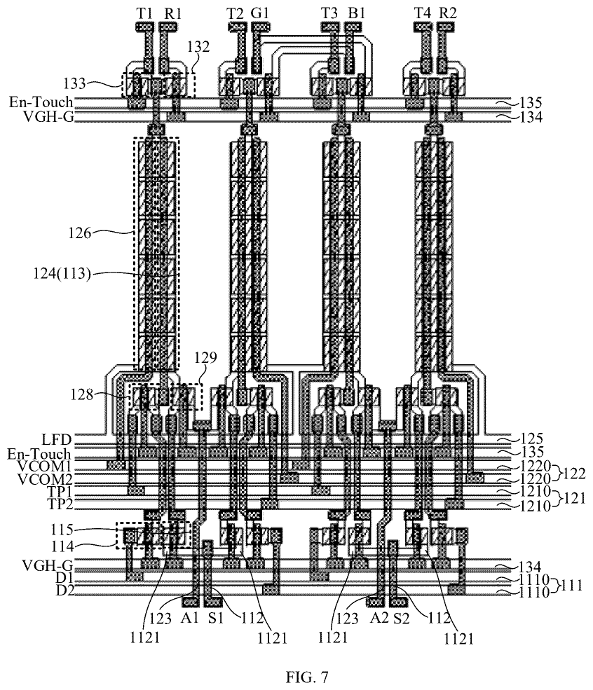

In some embodiments, on the basis that the display switches 113 and the detection switches 124 are the multiplexing switches, FIG. 6 shows a schematic structural diagram of another signal selection circuit 12, and FIG. 7 shows a physical diagram of the structure shown in FIG. 6. As shown in FIGS. 6 and 7 and with reference to the timing diagram shown in FIG. 4, the touch signal selection circuit 120 further includes a compensation selector line 122, compensation switches 126, and a compensation signal line 125.

Specifically, the display switches 113 and the detection switches 124 are the multiplexing switches at this time. Accordingly, the compensation switches 126 include the switches g1/g2/g3/g4 in FIG. 6. The compensation selector line 122 includes compensation selection lines 1220 in FIG. 6 for transmitting signals VCOM1/VCOM2. The compensation signal line 125 includes a line of FIG. 6 for transmitting a touch signal LFD.

The compensation selector line 122 includes a plurality of compensation selection lines 1220. Each of the compensation selection lines 1220 is electrically connected to gates of a plurality of compensation switches 126 and is configured to turn on or turn off the compensation switches 126. The compensation signal line 125 is electrically connected to the timing selection circuit 130 by the plurality of compensation switches 126.

The timing selection circuit 130 includes a plurality of sub-selection groups 136, each of which is correspondingly electrically connected to a respective display data line and a respective touch signal line. A drain of each of the compensation switches 126 and a drain of a corresponding detection switch 124 are electrically connected to the same sub-selection group 136. The compensation switch 126 and the detection switch 124, which are electrically connected to the same sub-selection group 136, are alternately turned on during a period in which the display panel 10 is in the touch mode 102.

Specifically, in the partial structure shown in FIG. 6, when the second timing switch 133 is turned on, the first timing switch 132 is turned off, the switch a1 and the switch d1 are turned off, the display signal S1 cannot pass through the switch a1, and the signal D1 cannot pass through the switch d1. Since the switch c1 is turned on and the switch f1 is turned off, the touch signal line T1 is electrically connected to the touch signal selection circuit 120.

The signal VCOM1 is transmitted to the gate of the switch g1 to control the switch g1. The switch g1 controls whether or not the compensation signal LFD passes through the switch g1. If the switch h1 is turned on, the switch g1 is turned off. If the switch h1 is turned off, the switch g1 is turned on, and the compensation signal LFD is transmitted to the timing selection circuit 130 through the switch g1 and then to the touch signal line T1 through the switch c1. Other portions of the touch signal selection circuit 120 may also be driven in such a manner as to refer to this portion.

In addition, for adjacent touch electrodes or adjacent touch blocks including a plurality of touch electrodes, the touch electrode or the touch block that receives the compensation signal is configured to avoid a coupling capacitance, which affects the recognition of the touch object, between the touch electrode or the touch block that receives the compensation signal and the touch electrode or the touch block receiving the touch signal.

With the above arrangement, it is possible to realize the touch function by electrically connecting the touch signal selection circuit 120 to the touch signal line or the display function by electrically connecting the display signal selection circuit 110 to the display data line in different modes of the display panel, while improving the touch detection accuracy of the display panel 10, so that the integrated design of the display signal selection circuit 110 and the touch signal selection circuit 120 can be realized in another manner, and the problem of signal short-circuit in the line formed after the integration can be avoided by the first timing switch 132 and the second timing switch 133. Furthermore, the width W of the bezel of the display panel 10 occupied by the display signal selection circuit 110 and the touch signal selection circuit 120, that is, the width W shown in FIG. 2, can be reduced without affecting the operation of the display panel 10.

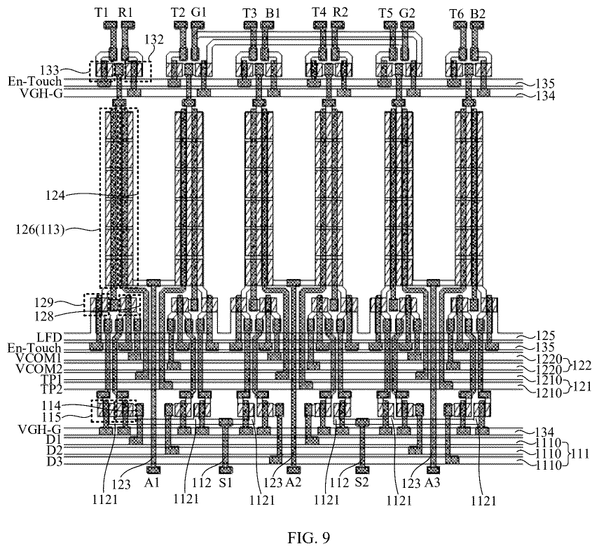

In some embodiments, the detection switches 124 and the display switches 113 are not multiplexing switches. FIG. 8 is a schematic structural diagram of another signal selection circuit 12, and FIG. 9 is a physical diagram of the structure shown in FIG. 8. As shown in FIGS. 8 and 9 and with reference to the timing diagram shown in FIG. 4, the touch signal selection circuit 120 further includes a compensation selector line 122, compensation switches 126, and a compensation signal line 125.

The compensation selector line 122 includes a plurality of compensation selection lines 1220. Each of the compensation selection lines 1220 is electrically connected to a plurality of fourth timing switches 128, then to gates of compensation switches 126 through the fourth timing switches 128, and is configured to control turned-on and turn-off operations of the compensation switches 126 when the fourth timing switches 128 are turned on. The compensation signal line 125 is electrically connected to the plurality of sixth timing switches 129, and is electrically connected to the source of the compensation switches 126 through the sixth timing switches 129, that is, the compensation signal line 125 is electrically connected to the sources of the compensation switches 126 through the sixth timing switches 129 when the sixth timing switches 129 are turned on. The compensation signal line 125 is electrically connected to the timing selection circuit 130 through the compensation switches 126. The gates of the sixth timing switches 129, the fourth timing switches 128, and the second timing switches 133 receive the same timing signal.

Specifically, the fourth timing switches 128 include switches e1/e2/e3/e4/e5/e6. The sixth timing switches 129 include switches b1/b2/b3/b4/b5/b6. The gates of the sixth timing switches 129, the fourth timing switches 128, and the second timing switches 133 may each receive a signal En-Touch.

The pixel selector line 111 includes a plurality of sub-pixel selection lines 1110. Each of the sub-pixel selection lines 1110 is electrically connected to a plurality of third timing switches 114, then to gates of a corresponding plurality of display switches 113 after passing through the plurality of third timing switches 114, and is configured to turn on or turn off the display switches 113 when the third timing switches 114 are turned on. The display signal line 112 is electrically connected to the plurality of fifth timing switches 115, and is electrically connected to the sources of the corresponding plurality of display switches 113 through the plurality of fifth timing switches 115. The gates of the fifth timing switches 115, the third timing switches 114 and the first timing switches 132 receive the same timing signal.

Specifically, the third timing switches 114 include switches d1/d2/d3/d4/d5/d6. The fifth timing switches 115 include switches a1/a2/a3/a4/a5/a6. The gates of the fifth timing switches 115, the third timing switches 114, and the first timing switches 132 may each receive a signal VGH-G.

The compensation switches 126 and the display switches 113 are multiplexing switches, and each of the gates of the multiplexing switches is electrically connected to a corresponding sub-pixel selection line 1110 and a compensation selection line 1220.

Specifically, the display switches 113 and the detection switches 124 are multiplexing switches at this time. Accordingly, each of the display switches 113 and the compensation switches 126 include switches g1/g2/g3/g4 in FIG. 6. The compensation selector line 122 includes the compensation selection lines 1220 in FIG. 6 for transmitting signals VCOM1/VCOM2. The compensation signal line 125 includes the line of FIG. 6 for transmitting the touch signal LFD.

The timing selection circuit 130 includes a plurality of sub-selection groups 136, each of which is correspondingly electrically connected to a respective display data line and a respective touch signal line. The drain of each of the compensation switches 126 and the drain of the corresponding detection switch 124 are electrically connected to the same sub-selection group 136. The compensation switch 126 and the detection switch 124, which are connected to the same sub-selection group 136, are alternately turned on during the period in which the display panel 10 is in the touch mode 102.

Taking the partial structure shown in FIG. 8 as an example, when the second timing switch 133 is turned on, the first timing switch 132 is turned off, the switch a1 and the switch d1 are turned off, the display signal S1 cannot pass through the switch a1, and the signal D1 cannot pass through the switch d1. Since the switch c1 is turned on and the switch f1 is turned off, the touch signal line T1 is electrically connected to the touch signal selection circuit 120.

In addition, when the second timing switch 133 is turned on, the switch b1 and the switch e1 are turned on. The signal VCOM1 is transmitted to the gate of the switch g1 after passing through the switch e1, so as to control the switch g1. The switch g1 controls whether or not the compensation signal LFD passes through the switch g1. If the switch h1 is turned on, the switch g1 is turned off, and the touch signal A1 is transmitted to the timing selection circuit 130 through the switch h1 and then to the touch signal line T1 through the switch c1. If the switch h1 is turned off, the switch g1 is turned on, and the compensation signal LFD is transmitted to the timing selection circuit 130 through the switch g1 and then to the touch signal line T1 through the switch c1. Other portions of the touch signal selection circuit 120 may be driven in such a manner as to refer to this portion.

When the second timing switch 133 is turned off, the first timing switch 132 is turned on, the switch b1 and the switch e1 are turned off, and the switch h1 is also turned off, so that the compensation signal LFD cannot pass through the switch b1, and the signal VCOM1 cannot pass through the switch e1. Since the switch c1 is turned off and the switch f1 is turned on, the display data line R1 receives the display signal S1, and the touch signal line T1 does not receive the compensation signal LFD or the touch signal A1.

Meanwhile, the first timing switch 132 is turned on, and the switch a1 and the switch d1 are turned on. The signal D1 is transmitted to the gate of the switch g1 to control the switch g1. The switch g1 controls whether or not the display signal S1 passes through the switch g1. If the display signal S1 passes through the switch g1, the display signal S1 is transmitted to the display data line R1 through the switch f1. Other portions of the display signal selection circuit 110 may also be driven in such a manner as to refer to this portion.

With the above arrangement, it is possible to realize the touch function by electrically connecting the touch signal selection circuit 120 to the touch signal line or the display function by electrically connecting the display signal selection circuit 110 to the display data line in different modes of the display panel. Thus, the integrated design of the display signal selection circuit 110 and the touch signal selection circuit 120 can be realized, and the problem of signal short-circuit in the line formed after the integration can be avoided by the first timing switch 132 and the second timing switch 133. Furthermore, the width W of the bezel of the display panel 10 occupied by the display signal selection circuit 110 and the touch signal selection circuit 120, that is, the width W shown in FIG. 2, can be reduced without affecting the operation of the display panel 10.

It should be noted that for the wiring diagrams of the other embodiments of the present disclosure, reference may also be made to the timing diagram shown in FIG. 4.

In some embodiments, as shown in the timing diagram of FIG. 4, the signal CK and the signal CKB are sequentially set to a high level during the period in which the display panel 10 is in the display mode 101. Each of the signals CK/CKB is a clock signal, and is configured to sequentially control different gate driving units (GOA) to output gate driving signals. When the signal CK controls the gate line of N-th row to be provided with a turn-on signal, the display signal is sequentially applied to different display data lines when the gate line is provided with the turn-on signal. At the same time, the signal CKB controls the gate line of (N+1)-th row to be provided with a turn-on signal, and the display signal is sequentially applied to different display data lines when the gate line is provided with the turn-on signal. When the gate line is provided with the turn-on signal, the sub-pixels electrically connected to the gate line receive the display signals transmitted from the display data lines at the same time, so that the sub-pixels can perform the light-emitting function in a controlled manner.

It should be noted that it is merely a possible embodiment to set the signal CK and the signal CKB simultaneously, but other embodiments are not limited by this embodiment, for example, only one signal CK may be provided. By setting the signal CK and the signal CKB to scan different gate lines alternately in sequence, the problem of threshold value drift of the driving transistor in the display panel 10 can be avoided.

In addition, in the timing diagram shown in FIG. 4, each of the signals TP1/TP2/VCOM1/VCOM2, the compensation signal LFD, and the touch signal A includes a modulation level within a period in which the display panel 10 is in the touch mode 102. The modulation level is greater than the low level and less than the high level, and the modulation levels included in the above various signals not only have the same interval frequency, but also correspond to each other and are synchronized with each other during the period. Here, it is not necessary to add the modulation level to the signal TP1 and the signal VCOM2 during a first period 1021 and to the signal TP2 and the signal VCOM1 during a second period 1022, but only to control these signals to be the high level through gates during the corresponding period.

By adding the modulation level in each of the above signals, it is possible to ensure that during a period in which the display panel 10 is in the touch mode 102, the frequency of the touch signal A can be kept in synchronization with the frequency of the other signals as described above, so that it is possible to avoid abnormal fluctuation of the capacitance value of the touch electrode due to the signal frequency non-synchronization between the other signals and the touch signal A. That is, it may be avoided that when the touch signal A transmitted by the touch signal line is in a valley part of the frequency, the above other signals are in a peak part of the frequency because the above other signals are not in frequency synchronization with the touch signal A, and the electromagnetic field generated by the above other signals in the peak part of the frequency interferes with the capacitance value of the touch electrode. Therefore, it is possible to avoid affecting the detection accuracy of the touch signal A.

It should be noted that the concept of the modulation level is introduced for ease of explanation.

It should also be noted that the signals D1/D2/D3 shown in FIG. 4 have a cycle in the order of D1, D2, D3, D3, D2, D1, but it is not limited in other embodiments. For example, the signals D1/D2/D3 may also have a cycle in the order of D1, D2, D3, D1, D2, D3.

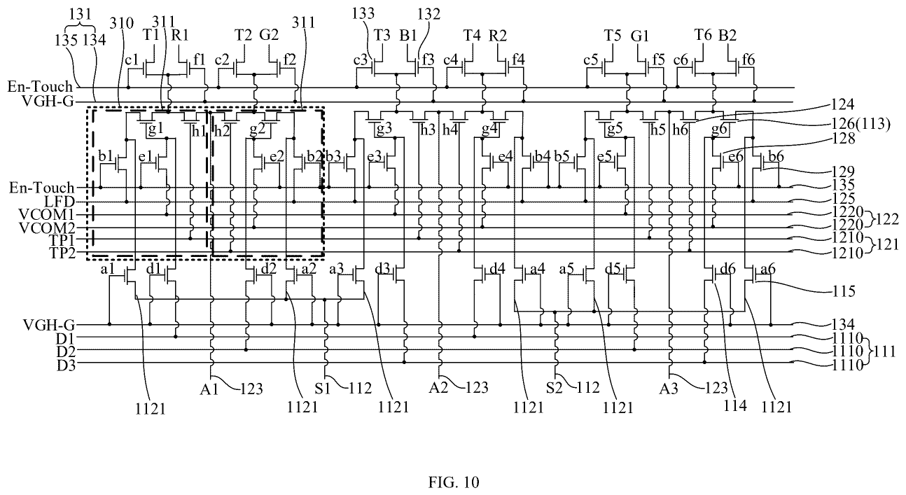

In some embodiments, FIG. 10 shows another configuration division of the signal selection circuit 12 of FIG. 8. As shown in FIGS. 8 and 10 and with reference to the timing diagram shown in FIG. 4, the display panel 10 further includes a plurality of touch driving units 310. The plurality of touch driving units 310 are electrically connected to the same compensation selector line 122, the same touch selector line 121, and the same compensation signal line 125.

Each of the touch driving units 310 includes at least two sub-touch driving groups 311, which are electrically connected to at least two adjacent touch signal lines respectively. Each of the at least two sub-touch driving groups 311 includes two timing switches 128/129, one detection switch 124, and one display switch 113. Since the display switches 113 and the compensation switches 126 are the multiplexing switches, the display switch 113 herein may also be described as the compensation switch 126. The at least two sub-touch driving groups 311 in the same touch driving unit 310 share the same touch detection line 123, which is electrically connected to the two detection switches 124.

Taking the content shown in FIG. 10 as an example, the switches b1/b2, the switches e1/e2, the switches g1/g2, and the switches h1/h2 are included in the same touch driving unit 310. The switch b1, the switch e1, the switch g1, and the switch h1 are included in one sub-touch driving group 311 in the touch driving unit 310, and the switch b2, the switch e2, the switch g2, and the switch h2 are included in another sub-touch driving group 311 in the touch driving unit 310. The two sub-touch driving groups 311 share the same touch detection line 123.

In addition, each of the touch driving units 310 may include two sub-touch driving groups 311, which are electrically connected to two adjacent touch signal lines respectively. Alternatively, each of the touch driving units 310 may include three sub-touch driving groups 311, which are electrically connected to three adjacent touch signal lines respectively. Alternatively, each of the touch driving units 310 may include four sub-touch driving groups 311, which are electrically connected to four adjacent touch signal lines respectively. Alternatively, each of the touch driving units 310 may include five sub-touch driving groups 311, which are electrically connected to five adjacent touch signal lines respectively, but embodiments are not limited thereto.

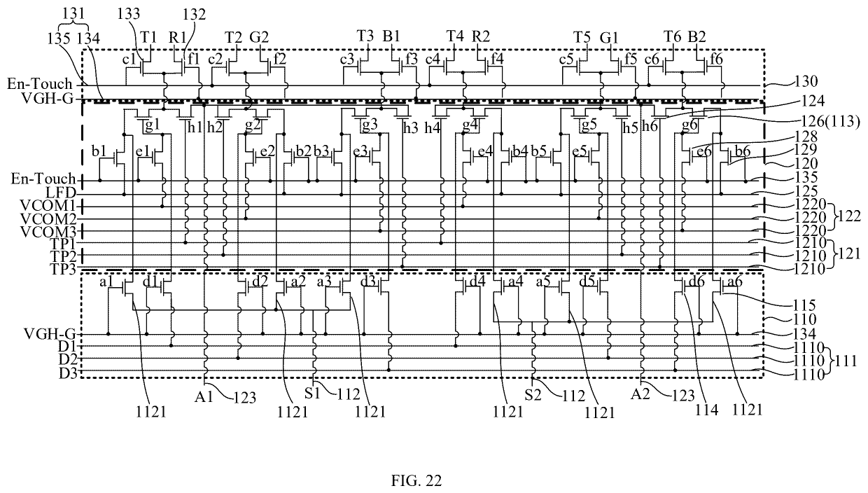

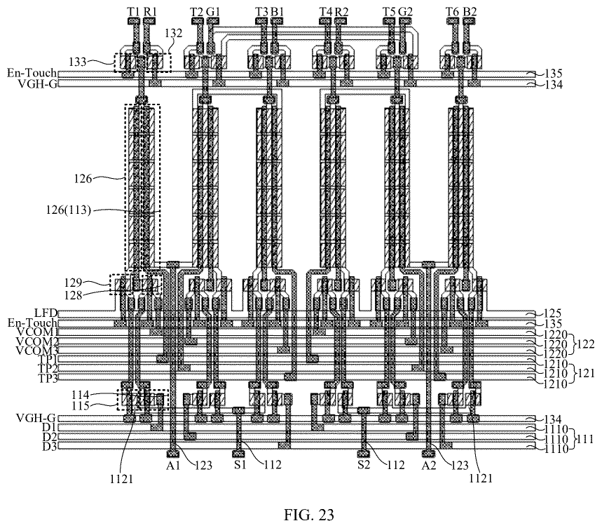

Herein, a solution in which each of the touch driving units 310 includes three sub-touch driving groups 311 may refer to a schematic structural diagram of another signal selection circuit 12 shown in FIG. 22, and a physical diagram, which corresponds to the wiring integration solution shown in FIG. 22, shown in FIG. 23. In addition, a solution in which each of the touch driving units 310 includes more sub-touch driving groups 311 may be derived based on the above.

It should be noted that the division method of the touch driving unit 310 is to further clarify the driving method of the touch signal selection circuit 120. Therefore, the division method does not conflict with the foregoing description of the signal selection circuit 12.

The at least two sub-touch driving groups of each of the touch driving units are electrically connected to at least two sub-touch selection lines 1210 respectively, and are electrically connected to at least two compensation selection lines 1220 respectively.

When the display panel 10 is in the touch mode 102, during a first period 1021, one sub-touch driving group is electrically connected to the touch detection line 123 and the other sub-touch driving group is electrically connected to the compensation signal line 125, and during a second period 1022, the objects, to which the two sub-touch driving groups are electrically connected respectively, are interchanged.

Specifically, taking the partial structure shown in FIG. 8 as an example, during the first period 1021 of the period corresponding to the touch mode 102 shown in FIG. 4, the signal TP1 is at a high level, the signal TP2 is at a low level, the signal VCOM1 is at a low level, and the signal VCOM2 is at a high level. Thus, during the first period 1021, the switch h1 is turned on, the switch h2 is turned off, the switch g1 is turned off, and the switch g2 is turned on. At this time, the touch signal A1 is transmitted to the touch signal line T1 via the switch h1. Meanwhile, the compensation signal LFD reaches the touch signal line T2 through the switch g2.

In this case, the touch signal line T1 to which the touch signal A1 is applied is configured to detect the touch object. The compensation signal LFD applied to the touch signal line T2 is configured to reduce the probability of forming a coupling capacitor with the adjacent touch signal line to which the touch signal A1 is applied, so as to prevent the detecting function of the touch signal line to which the touch signal A1 is applied from being influenced after forming the coupling capacitor.

During the second period 1022 of the period of the touch mode 102, the signal TP1 is at a low level, the signal TP2 is at a high level, the signal VCOM1 is at a high level, and the signal VCOM2 is at a low level. Therefore, during the second period 1022, the switch h1 is turned off, the switch h2 is turned on, the switch g1 is turned on, and the switch g2 is turned off. At this time, the touch signal A1 is transmitted to the touch signal line T2 via the switch h2. Meanwhile, the compensation signal LFD reaches the touch signal line T1 through the switch g1.

By alternately applying the compensation signal LFD and the touch signal A1 to adjacent touch signal lines during the first period 1021 and the second period 1022, detection of the touch signal by the display panel 10 can be realized.

With the above arrangement, the integrated design of the display signal selection circuit 110 and the touch signal selection circuit 120 can be realized, and the problem of signal short-circuit in the line formed after the integration can be avoided by the first timing switch 132 and the second timing switch 133, so that the width W of the bezel of the display panel 10 occupied by the display signal selection circuit 110 and the touch signal selection circuit 120, that is, the width W shown in FIG. 2, can be reduced without affecting the operation of the display panel 10.

It should be noted that the present embodiment adopts a design that each of the touch driving units includes two touch driving groups and the two touch driving groups share the same touch detection line 123, which is limited by the specification of the driving chip 15. However, embodiments are not limited thereto, the design in which one touch driving unit includes more touch driving groups may be applied according to the improvement of the specification of the driving chip 15.

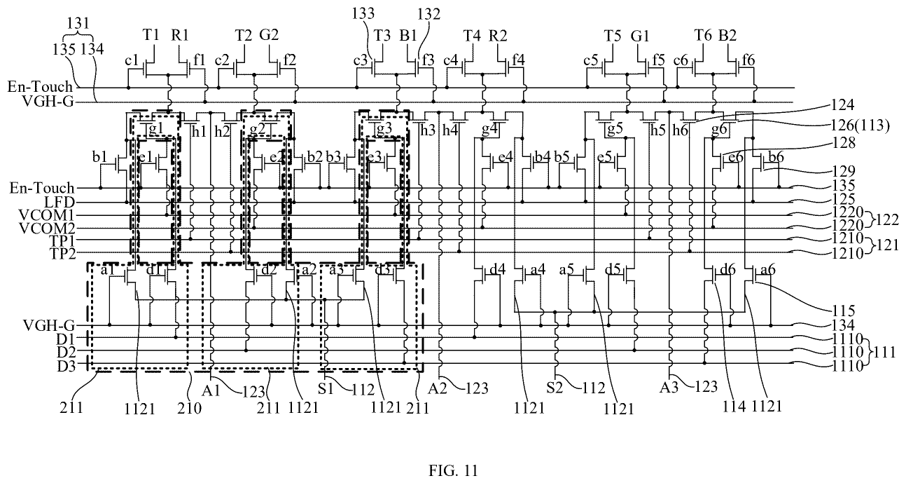

In some embodiments, FIG. 11 illustrates another configuration division of the signal selection circuit 12 of FIG. 8. As shown in FIGS. 8 and 11 and with reference to the timing diagram shown in FIG. 4, the display panel 10 further includes a plurality of display driving units 210. The plurality of the display driving units 210 are electrically connected to the same pixel selector line 111. Each of the display driving units 210 is electrically connected to one display signal line 112.

Each of the display driving units 210 includes at least two sub-display driving groups 211, each of which includes at least two timing switches 114/115 and one display switch 113. Since the display switches 113 and the compensation switches 126 are the multiplexing switches herein, the display switch 113 herein may also be described as the compensation switch 126. The pixel selector line 111 includes at least two sub-pixel selection lines 1110. The at least two sub-display driving groups 211 of each of the display driving units 210 are correspondingly electrically connected to at least two sub-pixel selection lines 1110, respectively.

Specifically, the pixel selector line 111 includes at least two sub-pixel selection lines 1110, that is, the pixel selector line 111 may include two sub-pixel selection lines 1110, or the pixel selector line 111 may include three sub-pixel selection lines 1110, or the pixel selector line 111 may include four sub-pixel selection lines 1110, or the pixel selector line 111 may include five sub-pixel selection lines 1110, but embodiments are not limited thereto.

It should be noted that the division method of the display driving unit 210 is to further clarify the driving method of the display signal selecting circuit 110. Therefore, the division method does not conflict with the foregoing description of the signal selection circuit 12.

The at least two sub-pixel selection lines 1110 are electrically connected to the at least two display switches 113 through at least two third timing switches 114 located in the same display driving unit 210 respectively. The display signal line 112 branches into at least two display signal branches 1121, which are electrically connected to the at least two display switches 113 through the other at least two fifth timing switches 115 located in the same display driving unit 210 respectively, and are electrically connected to the at least two display data lines through the display switches 113 respectively. When the display panel 10 is in the display mode, the first timing switches 132 are turned on, and the display signal is transmitted to the display data lines.

Specifically, the partial structure of FIG. 3 is also taken as an example. In the period corresponding to the display mode 101 shown in FIG. 4, the signal VGH-G is at a high level, the signal En-Touch is at a low level, and the switches a1/d1/a2/d2/a3/d3 located in the same display driving unit 210 are turned on. The signals D1/D2/D3 transmitted by the pixel selector line 111 are transmitted to gates of the switches g1/g2/g3 to control the turn-on and turn-off operations of the switches g1/g2/g3, respectively. At the same time, during the period of the display mode 101, the signals D1/D2/D3 are respectively set to the high level in different periods.

Here, when the signal D1 is at the high level, the switch g1 is turned on. The signal S1 transmitted by the display signal line 112 passes through the switch a1 via one display signal branch 1121 and is transmitted to the display data line R1 through the turned-on switch g1.

When the signal D2 is at the high level, the switch g2 is turned on. The signal S1 transmitted by the display signal line 112 passes through the switch a2 via one display signal branch 1121 and is transmitted to the display data line G2 through the turned-on switch g2.

When the signal D3 is at the high level, the switch g3 is turned on. The signal S1 transmitted by the display signal line 112 passes through the switch a3 via one display signal branch 1121 and is transmitted to the display data line B1 through the turned-on switch g3.

With the above arrangement, the integrated design of the display signal selection circuit 110 and the touch signal selection circuit 120 can be realized, and the problem of signal short-circuit in the line formed after the integration can be avoided by the first timing switch 132 and the second timing switch 133, so that the width W of the bezel of the display panel 10 occupied by the display signal selection circuit 110 and the touch signal selection circuit 120, that is, the width W shown in FIG. 2, can be reduced without affecting the operation of the display panel 10.

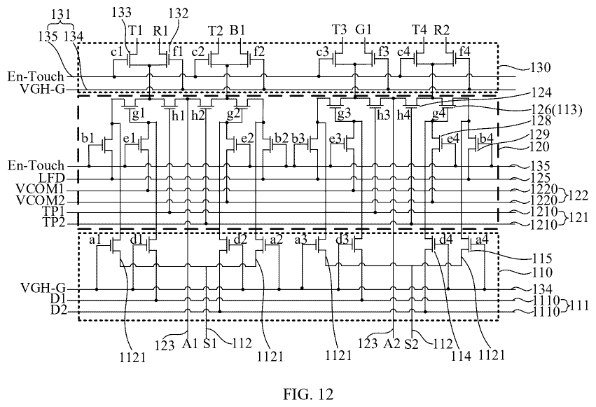

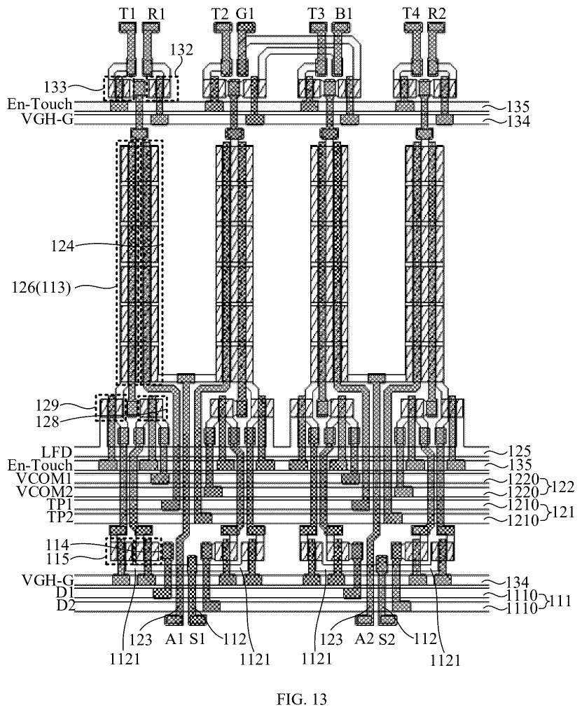

On the basis of the foregoing arrangement of the display driving unit 210, in some embodiments, a schematic structural diagram of another signal selection circuit 12 is shown in FIG. 12, and a physical diagram of the wiring integration scheme shown in FIG. 12 is shown in FIG. 13. As shown in FIGS. 12 and 13, the pixel selector line 111 includes two sub-pixel selection lines 1110. The display driving unit 210 includes four timing switches 114/115 and two display switches 113.

The two sub-pixel selection lines 1110 are electrically connected to the two display switches 113 through two third timing switches 114 located in the same display driving unit 210 respectively. The display signal line 112 branches into two display signal branches 1121, which are respectively electrically connected to the two display switches 113 through the other two fifth timing switches 115 in the same display driving unit 210, and are respectively electrically connected to the two display data lines after passing through the display switches 113. When the display panel 10 is in the display mode, the first timing switch 132 is turned on, and the display signal is transmitted to the display data line.

That is, in the present embodiment, the display signal line 112 branches into two display signal branches 1121, and the two display signal branches 1121 originating from the same display signal line 112 are correspondingly electrically connected to the two display data lines through two sub-display driving groups 211 in the display driving unit 210 that is electrically connected to the display signal line 112, so that the signal S1 or S2 transmitted by the display signal line 112 is correspondingly transmitted to the two display data lines during different periods, thereby enabling the display function of the display panel 10 to be realized.

With the above arrangement, the integrated design of the display signal selection circuit 110 and the touch signal selection circuit 120 can be realized, and the problem of signal short-circuit in the line formed after the integration can be avoided by the first timing switch 132 and the second timing switch 133, so that the width W of the bezel of the display panel 10 occupied by the display signal selection circuit 110 and the touch signal selection circuit 120, that is, the width W shown in FIG. 2, can be reduced without affecting the operation of the display panel 10.

On the basis of the foregoing arrangement of the display driving unit 210, in some embodiments, a schematic structural diagram of a signal selection circuit 12 is also shown in FIG. 8, and a physical diagram of the wiring integration scheme shown in FIG. 8 is shown in FIG. 9. As shown in FIGS. 8 and 9, the pixel selector line 111 includes three sub-pixel selection lines 1110. The display driving unit 210 includes six timing switches 115/114 and three display switches 113.

The three sub-pixel selection lines 1110 are electrically connected to the three display switches 113 through the three third timing switches 114 located in the same display driving unit 210, respectively. The display signal line 112 branches into three display signal branches 1121, which are respectively electrically connected to the three display switches 113 through the other three fifth timing switches 115 located in the same display driving unit 210, and are respectively electrically connected to the three display data lines after passing through the display switches 113. When the display panel 10 is in the display mode, the first timing switch 132 is turned on, and the display signal is transmitted to the display data line.

That is, in the present embodiment, the display signal line 112 branches into the three display signal branches 1121, and the three display signal branches 1121 originating from the same display signal line 112 are correspondingly electrically connected to the three display data lines through three sub-display driving groups 211 in the display driving unit 210 that is electrically connected to the display signal line 112, so that the signal S1 or S2 transmitted by the display signal line 112 is correspondingly transmitted to the three display data lines during different periods, thereby enabling the display function of the display panel 10 to be realized.

With the above arrangement, the integrated design of the display signal selection circuit 110 and the touch signal selection circuit 120 can be realized, and the problem of signal short-circuit in the line formed after the integration can be avoided by the first timing switch 132 and the second timing switch 133, so that the width W of the bezel of the display panel 10 occupied by the display signal selection circuit 110 and the touch signal selection circuit 120, that is, the width W shown in FIG. 2, can be reduced without affecting the operation of the display panel 10.

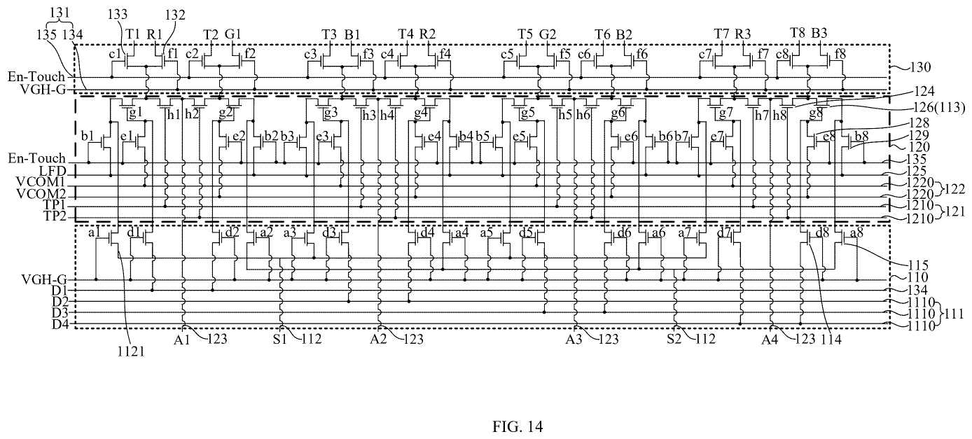

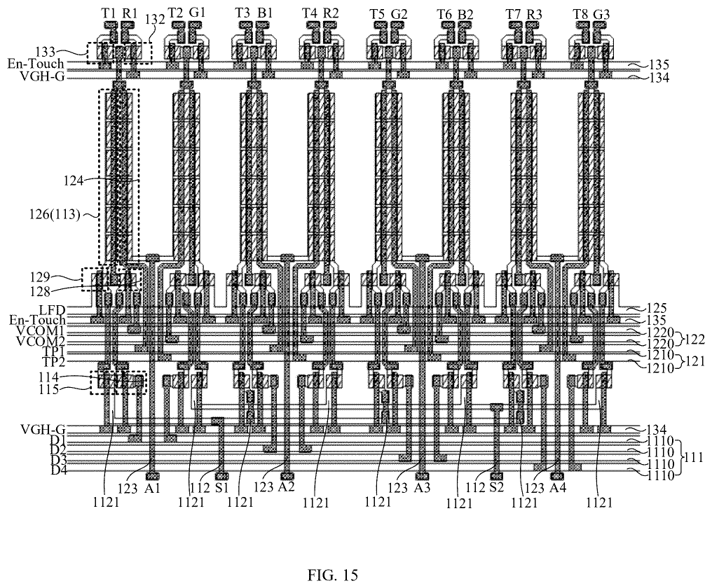

On the basis of the foregoing arrangement of the display driving unit 210, in some embodiments, a schematic structural diagram of another signal selection circuit 12 is shown in FIG. 14, and a physical diagram of the wiring integration scheme shown in FIG. 14 is shown in FIG. 15. As shown in FIGS. 14 and 15, the pixel selector line 111 includes four sub-pixel selection lines 1110. The display driving unit 210 includes eight timing switches 114/115 and four display switches 113.

The four sub-pixel selection lines 1110 are electrically connected to the four display switches 113 through four third timing switches 114 located in the same display driving unit 210 respectively. The display signal line 112 branches into four display signal branches 1121, which are respectively electrically connected to the four display switches 113 through the other four fifth timing switches 115 in the same display driving unit 210, and are respectively electrically connected to the four display data lines after passing through the display switches 113. When the display panel 10 is in the display mode, the first timing switch 132 is turned on, and the display signal is transmitted to the display data line.

That is, in the present embodiment, the display signal line 112 branches into four display signal branches 1121, and the four display signal branches 1121 originating from the same display signal line 112 are correspondingly electrically connected to the four display data lines through four sub-display driving groups 211 in the display driving unit 210 that is electrically connected to the display signal line 112, so that the signal S1 or S2 transmitted by the display signal line 112 is correspondingly transmitted to the four display data lines during different periods, thereby enabling the display function of the display panel 10 to be realized.

With the above arrangement, the integrated design of the display signal selection circuit 110 and the touch signal selection circuit 120 can be realized, and the problem of signal short-circuit in the line formed after the integration can be avoided by the first timing switch 132 and the second timing switch 133, so that the width W of the bezel of the display panel 10 occupied by the display signal selection circuit 110 and the touch signal selection circuit 120, that is, the width W shown in FIG. 2, can be reduced without affecting the operation of the display panel 10.

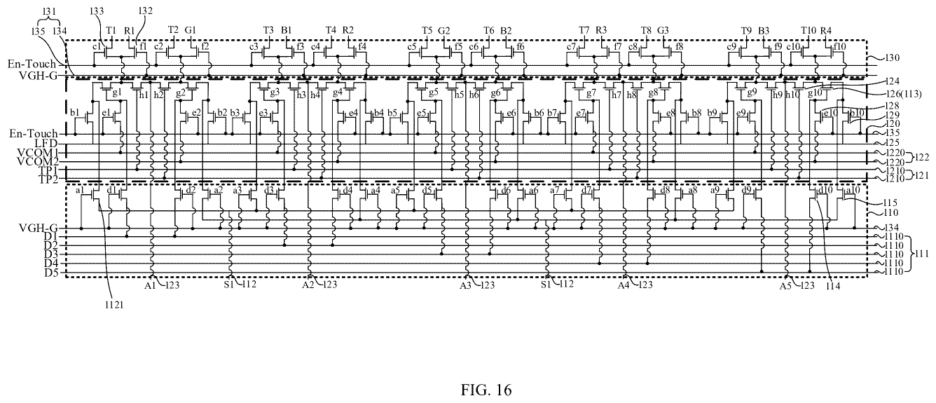

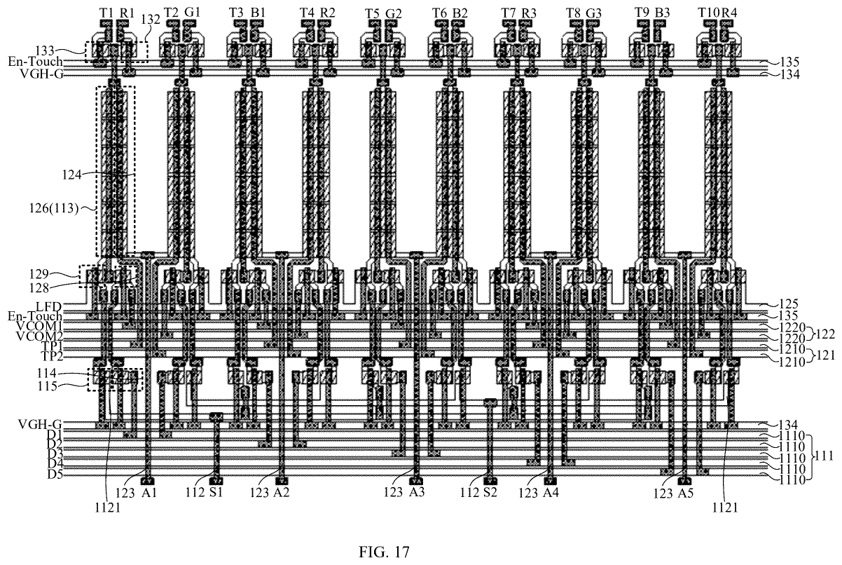

On the basis of the foregoing arrangement of the display driving unit 210, in some embodiments, a schematic structural diagram of another signal selection circuit 12 is shown in FIG. 16, and a physical diagram of the wiring integration scheme shown in FIG. 16 is shown in FIG. 17. As shown in FIGS. 16 and 17, the pixel selector line 111 includes five sub-pixel selection lines 1110. The display driving unit 210 includes ten timing switches 115/114 and five display switches 113.

The five sub-pixel selection lines 1110 are electrically connected to the five display switches 113 through the five third timing switches 114 located in the same display driving unit 210, respectively. The display signal line 112 branches into five display signal branches 1121, which are respectively electrically connected to the five display switches 113 through the other five fifth timing switches 115 located in the same display driving unit 210, and are respectively electrically connected to the five display data lines after passing through the display switches 113. When the display panel 10 is in the display mode, the first timing switch 132 is turned on, and the display signal is transmitted to the display data line.

That is, in the present embodiment, the display signal line 112 branches into five display signal branches 1121, and the five display signal branches 1121 originating from the same display signal line 112 are correspondingly electrically connected to the five display data lines through five sub-display driving groups 211 in the display driving unit 210 that is electrically connected to the display signal line 112, so that the signal S1 or S2 transmitted by the display signal line 112 is correspondingly transmitted to the five display data lines during different periods, thereby enabling the display function of the display panel 10 to be realized.

With the above arrangement, the integrated design of the display signal selection circuit 110 and the touch signal selection circuit 120 can be realized, and the problem of signal short-circuit in the line formed after the integration can be avoided by the first timing switch 132 and the second timing switch 133, so that the width W of the bezel of the display panel 10 occupied by the display signal selection circuit 110 and the touch signal selection circuit 120, that is, the width W shown in FIG. 2, can be reduced without affecting the operation of the display panel 10.

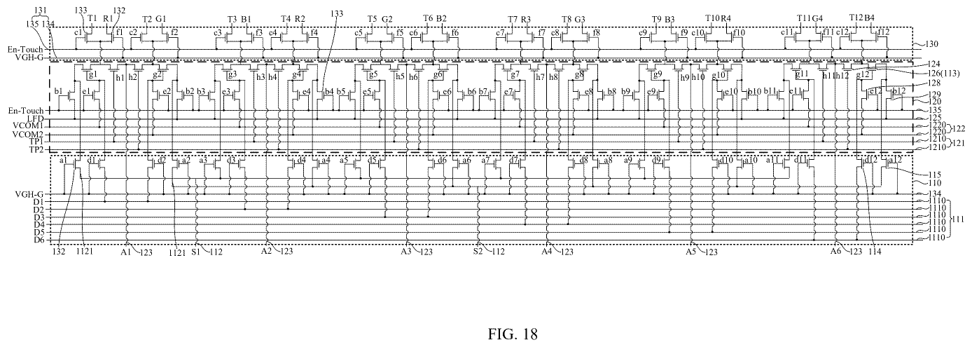

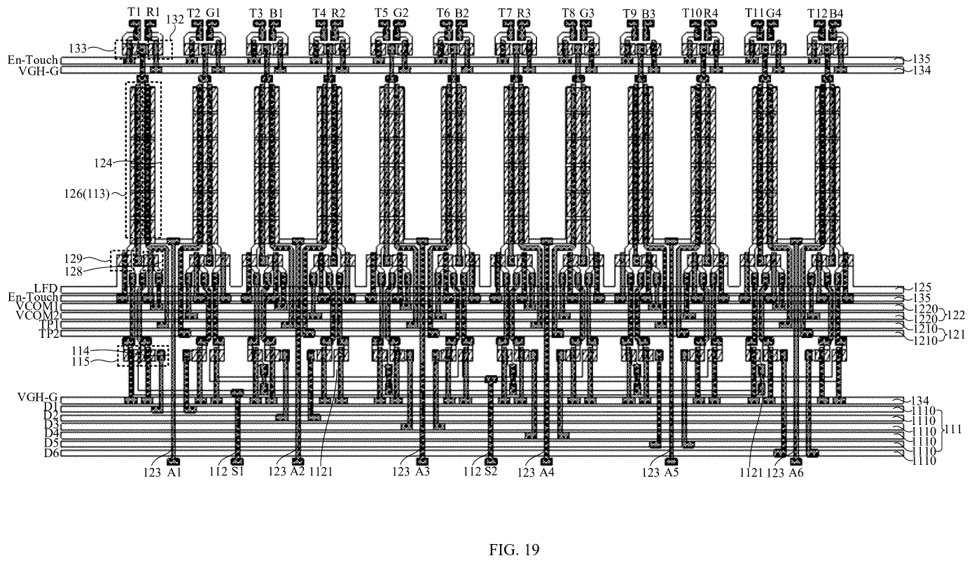

On the basis of the foregoing arrangement of the display driving unit 210, in some embodiments, a schematic structural diagram of another signal selection circuit 12 is shown in FIG. 18, and a physical diagram of the wiring integration scheme shown in FIG. 18 is shown in FIG. 19. As shown in FIGS. 18 and 19, the pixel selector line 111 includes six sub-pixel selection lines 1110. The display driving unit 210 includes twelve timing switches 115/114 and six display switches 113.

The six sub-pixel selection lines 1110 are electrically connected to the six display switches 113 through the six third timing switches 114 located in the same display driving unit 210, respectively. The display signal line 112 branches into six display signal branches 1121, which are respectively electrically connected to the six display switches 113 through the other six fifth timing switches 115 located in the same display driving unit 210, and are respectively electrically connected to the six display data lines after passing through the display switches 113. When the display panel 10 is in the display mode, the first timing switch 132 is turned on, and the display signal is transmitted to the display data line.

That is, in the present embodiment, the display signal line 112 branches into the six display signal branches 1121, and the six display signal branches 1121 originating from the same display signal line 112 are correspondingly electrically connected to the six display data lines through six sub-display driving groups 211 in the display driving unit 210 that is electrically connected to the display signal line 112, so that the signal S1 or S2 transmitted by the display signal line 112 is correspondingly transmitted to the six display data lines during different periods, thereby enabling the display function of the display panel 10 to be realized.

With the above arrangement, the integrated design of the display signal selection circuit 110 and the touch signal selection circuit 120 can be realized, and the problem of signal short-circuit in the line formed after the integration can be avoided by the first timing switch 132 and the second timing switch 133, so that the width W of the bezel of the display panel 10 occupied by the display signal selection circuit 110 and the touch signal selection circuit 120, that is, the width W shown in FIG. 2, can be reduced without affecting the operation of the display panel 10.

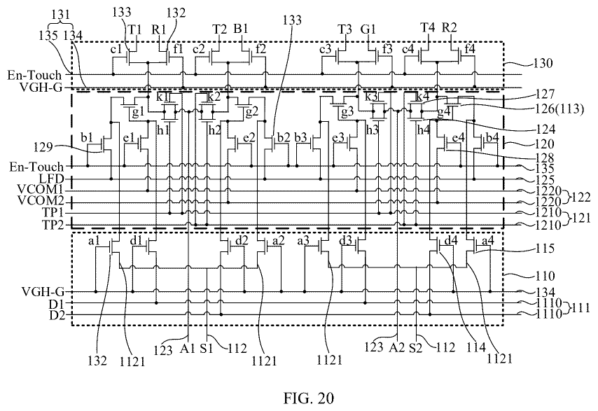

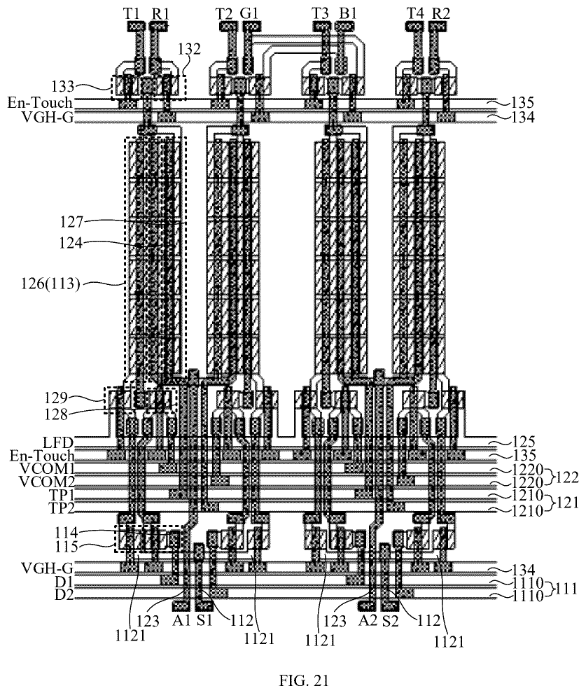

In some embodiments, FIG. 20 is a wiring diagram of another specific wiring integration scheme. FIG. 21 is a physical diagram of the wiring integration scheme shown in FIG. 20. As shown in FIGS. 20 and 21, the touch signal selection circuit 120 further includes a plurality of precision switches 127.

Each of the detection switches 124 is connected in parallel with at least one precision switch 127. The gate of each of the precision switches 127 and the gate of the detection switch 124 correspondingly connected in parallel with this precision switch 127 are electrically connected to the same sub-touch selection line 1210.

Specifically, as shown in FIG. 18, the precision switch 127 is connected in parallel with the detection switch 124, that is, the source and the drain of the precision switch 127 are correspondingly electrically connected to the source and the drain of the detection switch 124, and the sources and the drains of the precision switch 127 and the detection switch 124 that are correspondingly electrically connected with each other are respectively connected to wirings. For example, the sources and the drains of the switch h1 and the switch k1 are electrically connected with each other, and the sources and the drains of the switch h2 and the switch k2 are electrically connected with each other.

In addition, each of the detection switches 124 may be connected in parallel with one precision switch 127, or each of the detection switches 124 may be connected in parallel with two precision switches 127, or each of the detection switches 124 may be connected in parallel with three precision switches 127, or each of the detection switches 124 may be connected in parallel with four precision switches 127, but embodiments are not limited thereto.

When the signals TP1/TP2 transmitted by the sub-touch selection lines 1210 are transmitted to the detection switches 124 and the precision switches 127 correspondingly connected in parallel with these detection switches 124, the detection switches 124 and the precision switches 127 correspondingly connected in parallel with these detection switches 124 are simultaneously turned on. When the current of the touch signals A1/A2 passes through the detection switch 124 and the precision switch 127 that are connected in parallel with each other, the load that blocks the current in the detection switch 124 and the precision switch 127 corresponds to a resistance. In this case, the total resistance of the parallel resistors can be reduced by parallel connection of the resistors, that is, the resistance encountered when the current passes through the detection switch 124 and the precision switch 127 that are connected in parallel with each other is reduced, thereby reducing the loss of the touch signals A1/A2 when passing through the detection switch 124, and further improving the precision of the touch detection.

In some embodiments, as shown in FIG. 3 and FIGS. 5 to 23, two adjacent display driving units 210 are alternately electrically connected to display data lines. The display driving unit 210 is configured to alternately transmit the positive voltage signal and the negative voltage signal during different periods, and signals transmitted by two adjacent display driving units 210 during the same period are opposite to each other.

That is, referring to FIG. 3 and FIG. 16 of FIGS. 5 to 23 as an example, the display panel 10 includes display data lines R1/G1/B1/R2/G2/B2/R3/G3/B3. The display data line is configured to control the sub-pixels arranged in the row direction, or the sub-pixels arranged in the column direction, or the sub-pixels arranged in the other possible direction in the touch display structure 14.

When the display data lines are used for the sub-pixels arranged in the column direction, each of the display data lines is used for controlling the sub-pixels of the same column, and the light emitted by the sub-pixels of the same column has the same color. For example, the sub-pixels of the columns controlled by the display data lines R1/R2/R3 are configured to emit red light, the sub-pixels of the columns controlled by the display data lines G1/G2/G3 are configured to emit green light, and the sub-pixels of the columns controlled by the display data lines B1/B2/B3 are configured to emit blue light.

Two adjacent display driving units 210 are alternately electrically connected to display data lines. For example, in the two display driving units 210 for transmitting signals S1 and S2 respectively, the display driving unit 210 for transmitting the signal S1 is electrically connected to display data lines R1/B1/G2/R3/B3, and the display driving unit 210 for transmitting the signal S2 is electrically connected to display data lines G1/R2/B2/G3/R4. In addition, as shown in various physical diagrams, an embodiment of concretely realizing that the two adjacent display driving units 210 are electrically connected to the display data lines alternately may refer to FIG. 13 as an example, in which the two adjacent display driving units 210 are electrically connected to the corresponding display data lines through a plurality of display signal branches 1121 originating from the display signal lines 112, or refer to FIG. 8 as an example, in which a staggered connection design is performed for the first timing switches 132 that the display signal passes through last before being transmitted to the display data lines.

The display driving unit 210 alternately transmits the positive voltage signal and the negative voltage signal during different periods, and the signals transmitted by two adjacent display driving units 210 during the same period are opposite to each other, so that it is possible to realize a change in the light-emitting condition of sub-pixels of different columns or different rows, and therefore, it is possible to realize refreshing of the display contents of the display panel 10.

Therefore, the display contents of the display panel 10 can be refreshed while the integrated design of the display signal selection circuit 110 and the touch signal selection circuit 120 can be realized, and the problem of signal short-circuit in the line formed after the integration can be avoided by the first timing switch 132 and the second timing switch 133.

In some embodiments, as shown in FIG. 2, the display panel 10 further includes a liquid crystal structure and a supplemental power supply 13.

The liquid crystal structure includes a plurality of common electrodes 1401, a plurality of pixel electrodes, and a liquid crystal layer. The common electrode and the pixel electrode are located at the same side of the liquid crystal layer. The pixel electrode is electrically connected to the display data line, the common electrode 1401 is electrically connected to the touch signal line, one common electrode 1401 is reused as one touch electrode, one touch electrode is electrically connected to at least one touch signal line, and the display panel 10 includes the plurality of common electrodes 1401 arranged in an array. The liquid crystal structure is located in the touch display structure 14 shown in FIG. 2.

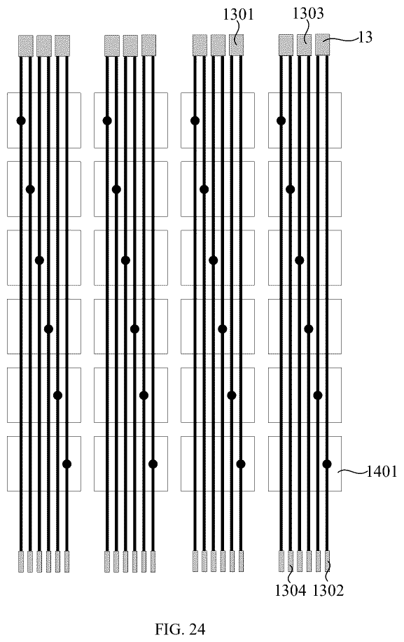

Referring to the schematic diagram of the electrical connection of the common electrode 1401 to the supplemental power supply 13 shown in FIG. 24, the supplemental power supply 13 is electrically connected to the common electrode 1401 and is configured to supply a supplemental voltage to the common electrode 1401 during the period in which the display panel 10 is in the display mode 101.

In general, when the display panel 10 is in the display mode 101, the touch signal selection circuit 120 is at a high level and supplies a voltage to the common electrode 1401 electrically connected to the touch signal selection circuit 120. At the same time, the display data line supplies different voltages to different pixel electrodes according to different display signals, so that an electric field is generated between the common electrode 1401 and the pixel electrode, and the deflection of liquid crystal molecules in the liquid crystal layer is controlled by the electric field. The light emitted from the backlight plate in the touch display structure 14 passes through the liquid crystal particles in different deflected states to emit light of different brightness, and then passes through the color filter layer in the touch display structure 14 to emit light of different colors from the touch display structure 14.

After the display signal selection circuit 110 is integrated with the touch signal selection circuit 120, the touch signal selection circuit 120 needs to maintain a low level when the display panel 10 is in the display mode 101. Therefore, the supplemental power supply 13 electrically connected to the common electrode 1401 is configured to supply the supplemental voltage to the common electrode 1401 during the period in which the display panel 10 is in the display mode 101, so that the problem that the touch signal selection circuit 120 is unable to apply the voltage to the common electrode 1401 at this time is overcome, and therefore, the normal display of the display panel 10 can be prevented from being affected.

It should be noted that the configuration of the supplemental power supply 13 is simple and can be made into a smaller size. Therefore, the addition of the supplemental power supply 13 does not affect the effect of reducing the width of the bezel of the display panel 10 occupied by the display signal selection circuit 110 and the touch signal selection circuit 120.

In some embodiments, as shown in FIGS. 2 and 24, the supplemental power supply 13 includes a first supplemental power supply 1301 and a second supplemental power supply 1302. The first supplemental power supply 1301 and the second supplemental power supply 1302 are located at both sides of the liquid crystal structure. For example, FIG. 2 shows a solution in which the first supplemental power supply 1301 and the second supplemental power supply 1302 are located at the upper and lower sides of the liquid crystal structure in the touch display structure 14. However, embodiments are not limited thereto. The first supplemental power supply 1301 and the second supplemental power supply 1302 may also be located at both sides of the liquid crystal structure in other directions.

The first supplemental power supply 1301 is provided with a plurality of first sub-power supplies 1303, and the second supplemental power supply 1302 is provided with a plurality of second sub-power supplies 1304. Each of the first sub-power supplies 1303 is electrically connected to two second sub-power supplies 1304, and is simultaneously electrically connected to two common electrodes 1401.

That is, each of the first sub-power supplies 1303 is electrically connected to two second sub-power supplies 1304 at the same time, and wirings for electrically connecting the first sub-power supply 1303 and the two second sub-power supplies 1304 are also electrically connected to the two common electrodes 1401 simultaneously.

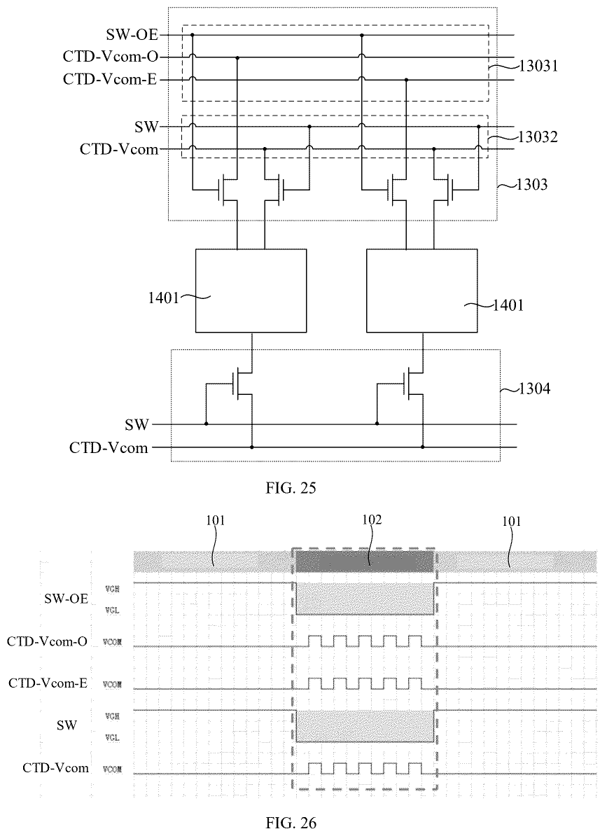

In addition, reference is made to FIG. 25 in which a wiring diagram for showing the electrical connection of the first sub-power supply 1303, the second sub-power supply 1304, and the common electrode 1401 is shown, and to FIG. 26 in which a timing diagram corresponding to FIG. 25 is shown. During the period in which the display panel 10 is in the display mode 101, the signals SW/SW-OE are at a high level, and three signals CTD-Vcom/CTD-Vcom-O/CTD-Vcom-E are configured to apply a supplemental voltage to the common electrode 1401. In this way, the common electrode 1401 is supplied with the supplemental voltage, and an electric field can be formed between the common electrode 1401 and the pixel electrode to control the deflection state of the liquid crystal particles in the liquid crystal layer. During the period in which the display panel 10 is in the touch mode 102, the signals SW/SW-OE are all at a low level, so that the influence on the detection of changes in the amount of the touch indication signal is avoided.

Meanwhile, the first sub-power supply 1303 includes two parts, that is, the first part 13031 and the second part 13032 shown in FIG. 23. The first part 13031 of the first sub-power supply 1303 may be used to detect whether there is a short circuit or the like between the wires at the beginning of the product design. Referring to the timing diagram shown in FIG. 26, when the detection is performed, the signal CTD-Vcom-O is configured to supply a voltage of 5 V, the signal CTD-Vcom-E is configured to supply a supplemental voltage, and a voltage is simultaneously applied to the pixel electrode. At this time, when the liquid crystal corresponding to the common electrode 1401 to which the signal CTD-Vcom-O is applied is deflected, white is displayed, and when the liquid crystal corresponding to the common electrode 1401 to which the signal CTD-Vcom-E is applied is not deflected, black is displayed. Therefore, a checkerboard pattern may appear in the touch display structure 14, that is, portions of the liquid crystal structure corresponding to the adjacent common electrodes or the adjacent pixel electrodes may display a black pattern and a white pattern respectively. In this case, if there is the short-circuit or the like in the wirings electrically connected to the common electrodes 1401 and the pixel electrodes, this defect can be directly detected based on whether the abnormal portion appears in the checkerboard pattern of the touch display structure 14.

With this arrangement, it is possible not only to supply the supplemental voltage to the common electrode 1401 during the period in which the display panel 10 is in the display mode 101, so as to compensate for the defect that the touch signal selection circuit 120 is unable to apply a voltage to the common electrode 1401 at this time, but also to facilitate the detection of faults in the wiring.

In some embodiments, as shown in FIGS. 2 and 3, the driving chip 15 is configured to at least transmit a timing signal, and the timing control signal is configured to drive the gate driving unit. The gates of the first timing switch 132 and the second timing switch 133 are configured to receive the timing signal.

Specifically, the timing control signal is a timing signal commonly used in the driving chip 15, and the driving chip 15 transmits a timing control signal for driving the gate driving unit to transmit a gate scanning signal, thereby controlling changes in the light-emitting states of the sub-pixels electrically connected to the display data lines according to different colors in sequence, row by row, or column by column, realizing a refresh change of the display content of the display panel 10, and further saving the number of the display signal lines 112.

Reference is made to the timing diagram shown in FIG. 4, in which signals VGH-G and En-Touch are both the timing signals. The changes in the level of the signals VGH-G and En-Touch coincides with the display mode 101 and the touch mode 102 of the display panel 10, and can be used to control the turn-on and turn-off operations of the first timing switch 132 and the second timing switch 133 in different modes of the display panel 10.

Therefore, based on the timing control signal, it is possible to control the turn-on and turn-off operations of the first timing switch 132 and the second timing switch 133 in different modes of the display panel 10. In addition, it is also possible to avoid the introduction of other control timing, so that the introduction of new control timing can be avoided on the basis of the control of the first timing switch 132 and the second timing switch 133, which avoids the situation that more pins of the driving chip 15 need to be occupied. Furthermore, the control of the first timing switch 132 and the second timing switch 133 can be realized without putting forward other requirements for the specification of the driving chip 15, thereby reducing the cost.

The present disclosure also provides a display device including any one of the above-described display panels.

The present disclosure also provides a method of controlling the display panel 10. As shown in FIGS. 3 and 5 to 23 and with reference to the timing diagram shown in FIG. 4, the display panel 10 includes the display signal selection circuit 110, the touch signal selection circuit 120, and the timing selection circuit 130.

The timing selection circuit 130 includes the plurality of timing selection lines 131, the plurality of first timing switches 132, and the plurality of second timing switches 133. Each of the timing selection lines 131 is electrically connected to gates of a corresponding plurality of first timing switches 132 or a corresponding plurality of second timing switches 133.

Both the display signal selection circuit 110 and the touch signal selection circuit 120 are electrically connected to the first timing switches 132 and the second timing switches 133 of the timing selection circuit 130. The timing selection circuit 130 is electrically connected to the display data line through the first timing switch 132, and is electrically connected to the touch signal line through the second timing switch 133.

When the display panel 10 is in the display mode 101, the first timing switch 132 is turned on and the second timing switch 133 is turned off according to the timing signal transmitted by the timing selection line 131. The display signal transmitted by the display signal selection circuit 110 is transmitted to the display data line through the timing selection circuit 130.

When the display panel 10 is in the touch mode 102, the first timing switch 132 is turned off and the second timing switch 133 is turned on according to the timing signal transmitted by the timing selection line 131. The touch signal transmitted by the touch signal selection circuit 120 is transmitted to the touch signal line through the timing selection circuit 130.

By introducing the first timing switch 132 and the second timing switch 133, and the corresponding timing selection circuit 130, and in combination with a corresponding control method, the corresponding signals can be transmitted by the plurality of timing selection lines 131 for different modes of the display panel 10 to control the turn-on or turn-off operations of the first timing switch 132 and the second timing switch 133, so as to realize that in the different modes of the display panel, the touch signal selection circuit 120 is electrically connected to the touch signal line, or the display signal selection circuit 110 is electrically connected to the display data line. Therefore, the integrated design of the display signal selection circuit 110 and the touch signal selection circuit 120 can be realized, and the problem of signal short-circuit in the line formed after integration is avoided by the first timing switch 132 and the second timing switch 133. Furthermore, the width W of the bezel of the display panel 10 occupied by the display signal selection circuit 110 and the touch signal selection circuit 120, that is, the width W shown in FIG. 2, can be reduced without affecting the operation of the display panel 10.

In some embodiments, as shown in FIGS. 3 and 5 to 23 and with reference to the timing diagram shown in FIG. 4, the touch signal selection circuit 120 includes a touch selector line 121, a plurality of touch detection lines 123, and a plurality of detection switches 124. The display signal selection circuit 110 includes a pixel selector line 111, a plurality of display signal lines 112, and a plurality of display switches 113.

The touch selector line 121 includes a plurality of sub-touch selection lines 1210. Each of the sub-touch selection lines 1210 is electrically connected to gates of a plurality of detection switches 124 and is configured to turn on or turn off the detection switches 124. The touch detection line 123 is electrically connected to the timing selection circuit 130 through a corresponding detection switch 124. The touch detection line 123 is electrically connected to the timing selection circuit 130 through the corresponding detection switch 124 when the detection switch 124 is turned on.

The pixel selector line 111 includes a plurality of sub-pixel selection lines 1110. Each of the sub-pixel selection lines 1110 is electrically connected to the gates of the plurality of display switches 113 and is configured to control the turn-on or turn-off operations of the display switches 113. The display signal line 112 is electrically connected to the timing selection circuit 130 through the corresponding display switch 113 when the display switch 113 is turned on.

With the above arrangement, the integrated design of the display signal selection circuit 110 and the touch signal selection circuit 120 can be realized concretely in combination with the control method, and the problem of signal short-circuit in the line formed after integration is avoided by the timing selection circuit 130, so that the width W of the bezel of the display panel 10 occupied by the display signal selection circuit 110 and the touch signal selection circuit 120, that is, the width W shown in FIG. 2, can be reduced without affecting the operation of the display panel 10.

In some embodiments, as shown in FIGS. 3 and 5 to 23 and with reference to the timing diagram shown in FIG. 4, the touch selector line 121 includes a plurality of sub-touch selection lines 1210. Each of the sub-touch selection lines 1210 is electrically connected to a plurality of fourth timing switches 128, is electrically connected to gates of a corresponding plurality of detection switches 124 through the plurality of fourth timing switches 128, and is configured to control the turn-on or turn-off operations of the detection switches 124 when the fourth timing switches 128 are turned on. The touch detection line 123 is electrically connected to a plurality of sixth timing switches 129, and is electrically connected to sources of a corresponding plurality of detection switches 124 through the plurality of sixth timing switches 129. The gates of the sixth timing switches 129, the fourth timing switches 128, and the second timing switches 133 receive the same timing signal.

The pixel selector line 111 includes a plurality of sub-pixel selection lines 1110. Each of the sub-pixel selection lines 1110 is electrically connected to a plurality of third timing switches 114, is electrically connected to gates of a corresponding plurality of display switches 113 through the plurality of third timing switches 114, and is configured to control the turn-on or turn-off operations of the display switches 113 when the third timing switches 114 are turned on. The display signal line 112 is electrically connected to a plurality of fifth timing switches 115, and is electrically connected to sources of a corresponding plurality of display switches 113 through the plurality of fifth timing switches 115. The gates of the fifth timing switches 115, the third timing switches 114, and the first timing switches 132 receive the same timing signal.

The detection switches 124 and the display switches 113 are multiplexing switches, and the corresponding sub-pixel selection lines 1110 and the corresponding sub-touch selection lines 1210 are electrically connected to gates of the multiplexing switches, the sub-pixel selection lines 1110 control the turn-on or turn-off operations of the switches when the third timing switches 114 and the fifth timing switches 115 are turned on, and the sub-touch selection lines 1210 control the turn-on or turn-off operations of the switches when the fourth timing switches 128 and the sixth timing switches 129 are turned on.

By providing the first timing switch 132 and the display signal selection circuit 110, and the second timing switch 133 and the touch signal selection circuit 120, and in combination with the corresponding control method, the detection switch 124 and the display switch 113 can be integrated as a multiplexing switch, so that the integrated design of the display signal selection circuit 110 and the touch signal selection circuit 120 can be further realized, and the problem of signal short-circuit in the line formed after the integration can be avoided by the timing selection circuit 130. Furthermore, the width W of the bezel of the display panel 10 occupied by the display signal selection circuit 110 and the touch signal selection circuit 120, that is, the width W shown in FIG. 2, can be reduced without affecting the operation of the display panel 10.

In some embodiments, as shown in FIGS. 3 and 5 to 23 and with reference to the timing diagram shown in FIG. 4, the touch signal selection circuit 120 further includes a compensation selector line 122, a compensation switch 126, and a compensation signal line 125.

The compensation selector line 122 includes a plurality of compensation selection lines 1220. Each of the compensation selection lines 1220 is electrically connected to gates of a plurality of compensation switches 126 and is configured to control the turn-on or turn-off operations of the compensation switches 126. The compensation signal line 125 is electrically connected to the timing selection circuit 130 by the plurality of compensation switches 126.

The timing selection circuit 130 includes a plurality of sub-selection groups 136, each of which is correspondingly electrically connected to a respective display data line and a respective touch signal line. A drain of each of the compensation switches 126 and a drain of a corresponding detection switch 124 are electrically connected to the same sub-selection group 136. The compensation switch 126 and the detection switch 124, which are electrically connected to the same sub-selection group 136, are alternately turned on during a period in which the display panel 10 is in the touch mode 102.

By the above arrangement in combination with the corresponding control method, it is possible to realize the touch function by electrically connecting the touch signal selection circuit 120 to the touch signal line or the display function by electrically connecting the display signal selection circuit 110 to the display data line in different modes of the display panel, while improving the touch detection accuracy of the display panel 10, so that the integrated design of the display signal selection circuit 110 and the touch signal selection circuit 120 can be realized in another manner, and the problem of signal short-circuit in the line formed after the integration can be avoided by the first timing switch 132 and the second timing switch 133. Furthermore, the width W of the bezel of the display panel 10 occupied by the display signal selection circuit 110 and the touch signal selection circuit 120, that is, the width W shown in FIG. 2, can be reduced without affecting the operation of the display panel 10.

In some embodiments, as shown in FIGS. 3 and 5 to 23 and with reference to the timing diagram shown in FIG. 4, the touch signal selection circuit 120 further includes a compensation selector line 122, a compensation switch 126, and the compensation signal line 125.

The compensation selector line 122 includes the plurality of compensation selection lines 1220. Each of the compensation selection lines 1220 is electrically connected to a plurality of fourth timing switches 128, is electrically connected to a gate of the compensation switch 126 through the fourth timing switch 128, and is configured to control the turn-on or turn-off operation of the compensation switch 126 when the fourth timing switch 128 is turned on. The compensation signal line 125 is electrically connected to the plurality of sixth timing switches 129, and is electrically connected to a source of the compensation switch 126 through the sixth timing switch 129. The compensation signal line 125 is electrically connected to the timing selection circuit 130 through the compensation switch 126. The gates of the sixth timing switches 129, the fourth timing switches 128 and the second timing switches 133 receive the same timing signal.

The pixel selector line 111 includes a plurality of sub-pixel selection lines 1110. Each of the sub-pixel selection lines 1110 is electrically connected to a plurality of third timing switches 114, is electrically connected to gates of a corresponding plurality of display switches 113 through the plurality of third timing switches 114, and is configured to control the turn-on or turn-off operations of the display switches 113 when the third timing switches 114 are turned on. The display signal line 112 is electrically connected to a plurality of fifth timing switches 115, and is electrically connected to sources of a corresponding plurality of display switches 113 through the plurality of fifth timing switches 115. The gates of the fifth timing switches 115, the third timing switches 114 and the first timing switches 132 receive the same timing signal.

The compensation switches 126 and the display switches 113 are multiplexing switches, and corresponding sub-pixel selection lines 1110 and corresponding compensation selection lines 1220 are electrically connected to the gates of the multiplexing switches. The sub-pixel selection line 1110 controls the turn-on or turn-off operation of the multiplexing switch when the third timing switch 114 and the fifth timing switch 115 are turned on, and the compensation selection line 1220 controls the turn-on or turn-off operation of the multiplexing switch when the fourth timing switch 128 and the sixth timing switch 129 are turned on.

The timing selection circuit 130 includes a plurality of sub-selection groups 136, each of which is correspondingly electrically connected to a respective display data line and a respective touch signal line. A drain of each of the compensation switches 126 and a drain of a corresponding detection switch 124 are electrically connected to the same sub-selection group 136. The compensation switch 126 and the detection switch 124, which are correspondingly connected to the same sub-selection group 136, are alternately turned on during the period in which the display panel 10 is in the touch mode 102.

By the above arrangement in combination with the corresponding control method, it is possible to realize the touch function by electrically connecting the touch signal selection circuit 120 to the touch signal line or the display function by electrically connecting the display signal selection circuit 110 to the display data line in different modes of the display panel. Thus, the integrated design of the display signal selection circuit 110 and the touch signal selection circuit 120 can be realized, and the problem of signal short-circuit in the line formed after the integration can be avoided by the first timing switch 132 and the second timing switch 133. Furthermore, the width W of the bezel of the display panel 10 occupied by the display signal selection circuit 110 and the touch signal selection circuit 120, that is, the width W shown in FIG. 2, can be reduced without affecting the operation of the display panel 10.

In some embodiments, as shown in FIGS. 3 and 5 to 23 and with reference to the timing diagram shown in FIG. 4, the display panel 10 further includes a plurality of touch driving units 310. The plurality of touch driving units 310 are electrically connected to the same compensation selector line 122, the same touch selector line 121, and the same compensation signal line 125.

Each of the touch driving units 310 includes at least two sub-touch driving groups 311, which are electrically connected to at least two adjacent touch signal lines respectively. Each of the at least two sub-touch driving groups 311 includes two timing switches 128/129, a detection switch 124, and a display switch 113. Since the display switch 113 and the compensation switch 126 are the multiplexing switch herein, the display switch 113 herein may also be described as the compensation switch 126. The at least two sub-touch driving groups 311 located in the same touch driving unit 310 share the same touch detection line 123, which is electrically connected to the two detection switches 124.

The at least two sub-touch driving groups 311 of each of the touch driving units 310 are electrically connected to at least two sub-touch selection lines 1210, respectively, and electrically connected to at least two compensation selection lines 1220, respectively.

When the display panel 10 is in the touch mode 102, during a first period 1021, one sub-touch driving group is electrically connected to the touch detection line 123, and the other sub-touch driving group is electrically connected to the compensation signal line 125, and during a second period 1022, the objects, to which the two sub-touch driving groups are electrically connected respectively, are interchanged.

By the above arrangement in combination with the corresponding control method, the integrated design of the display signal selection circuit 110 and the touch signal selection circuit 120 can be realized, and the problem of signal short-circuit in the line formed after the integration can be avoided by the first timing switch 132 and the second timing switch 133, so that the width W of the bezel of the display panel 10 occupied by the display signal selection circuit 110 and the touch signal selection circuit 120, that is, the width W shown in FIG. 2, can be reduced without affecting the operation of the display panel 10.

In some embodiments, as shown in FIGS. 3 and 5 to 23 and with reference to the timing diagram shown in FIG. 4, the display panel 10 further includes a plurality of display driving units 210. The plurality of the display driving units 210 are electrically connected to the same pixel selector line 111. Each of the display driving units 210 is electrically connected to one display signal line 112.

Each of the display driving units 210 includes at least two sub-display driving groups 211, each of which includes at least two timing switches 114/115 and one display switch 113. Since the display switches 113 and the compensation switches 126 are the multiplexing switches herein, the display switch 113 herein may also be described as the compensation switch 126. The pixel selector line 111 includes at least two sub-pixel selection lines 1110. The at least two sub-display driving groups 211 of each of the display driving units 210 are correspondingly electrically connected to at least two sub-pixel selection lines 1110, respectively.

When the display panel 10 is in the display mode 101, at least two sub-pixel selection lines 1110 are electrically connected to at least two display switches 113 through at least two third timing switches 114 located in the same display driving unit 210 respectively. The display signal line 112 branches into at least two display signal branches 1121, which are electrically connected to the at least two display switches 113 through the other at least two fifth timing switches 115 located in the same display driving unit 210 respectively, and are electrically connected to the at least two display data lines through the display switches 113 respectively.

By the above arrangement in combination with the corresponding control method, the integrated design of the display signal selection circuit 110 and the touch signal selection circuit 120 can be realized, and the problem of signal short-circuit in the line formed after the integration can be avoided by the first timing switch 132 and the second timing switch 133, so that the width W of the bezel of the display panel 10 occupied by the display signal selection circuit 110 and the touch signal selection circuit 120, that is, the width W shown in FIG. 2, can be reduced without affecting the operation of the display panel 10.

The above embodiments of the present disclosure can be complementary to each other without conflict.

It should be noted that in the drawings, the dimensions of the layers and regions may be exaggerated for clarity of the diagram. It may be appreciated that when an element or layer is referred to as being “on” another element or layer, it may be directly on the other element, or an intermediate layer may be present. In addition, it may be appreciated that when an element or layer is referred to as being “under” another element or layer, it may be directly under the other element, or one or more intermediate layers or elements may be present. In addition, it can also be understood that when a layer or element is referred to as being “between” two layers or two elements, it may be the only layer between the two layers or the two elements, or one or more intermediate layers or elements may also be present. Like reference numerals refer to like elements throughout.

The term “a plurality of” refers to two or more unless expressly defined otherwise.

A person skilled in the art will be able to easily conceive of other embodiments of the present disclosure after considering the specification and practice. The present disclosure is intended to cover any variations, uses or adaptative changes of the present disclosure that follow the general principles of the present disclosure and include common knowledge or customary technical means in the art not disclosed herein. The specification and embodiments are to be regarded as exemplary only, and the actual scope and spirit of the present disclosure are indicated by the appended claims.

It should be understood that the present disclosure is not limited to the specific structures already described above and illustrated in the accompanying drawings, and that various modifications and changes may be made without departing from the scope thereof. The scope of the present disclosure is limited only by the appended claims.

1. A display panel, comprising a display signal selection circuit, a touch signal selection circuit, and a timing selection circuit, wherein:
the timing selection circuit comprises timing selection lines, first timing switches, and second timing switches; and each of the timing selection lines is electrically connected to gates of corresponding ones of the first timing switches or gates of corresponding ones of the second timing switches; and
the display signal selection circuit and the touch signal selection circuit are both electrically connected to the first timing switches and the second timing switches; and the timing selection circuit is electrically connected to display data lines in the display panel through the first timing switches, and is electrically connected to touch signal lines in the display panel through the second timing switches.

2. The display panel according to claim 1, wherein the touch signal selection circuit comprises a touch selector line, touch detection lines, and detection switches; and the display signal selection circuit comprises a pixel selector line, display signal lines, and display switches;
the touch selector line comprises sub-touch selection lines; each of the sub-touch selection lines is electrically connected to gates of multiple detection switches of the detection switches and is configured to turn on or turn off the multiple detection switches; and the touch detection lines are electrically connected to the timing selection circuit through the detection switches; and
the pixel selector line comprises sub-pixel selection lines; each of the sub-pixel selection lines is electrically connected to gates of multiple display switches of the display switches and is configured to turn on or turn off the multiple display switches; and the display signal lines are electrically connected to the timing selection circuit through the display switches.

3. The display panel according to claim 2, wherein each of the sub-touch selection lines is electrically connected to fourth timing switches, and is electrically connected to gates of the multiple detection switches through the fourth timing switches; each of the touch detection line is electrically connected to sixth timing switches, and is electrically connected to sources of corresponding ones of the detection switches through the sixth timing switches; and gates of the sixth timing switches, gates of the fourth timing switches, and gates of the second timing switches receive the same timing signal;
each of the sub-pixel selection lines is electrically connected to third timing switches, and is electrically connected to gates of the multiple display switches through the third timing switches; each of the display signal line is electrically connected to fifth timing switches, and is electrically connected to sources of corresponding ones of the display switches through the fifth timing switches; and gates of the fifth timing switches, gates of the third timing switches, and gates of the first timing switches receive the same timing signal; and
the detection switches and the display switches are multiplexing switches, and the sub-pixel selection lines and the sub-touch selection lines are electrically connected to gates of the multiplexing switches.

4. The display panel according to claim 3, wherein the touch signal selection circuit further comprises a compensation selector line, compensation switches, and a compensation signal line;
the compensation selector line comprises compensation selection lines; each of the compensation selection lines is electrically connected to gates of multiple compensation switches of the compensation switches; and the compensation signal line is electrically connected to the timing selection circuit through the compensation switches; and
the timing selection circuit comprises sub-selection groups, each of which is electrically connected to a respective display data line of the display data lines and a respective touch signal line of the touch signal lines; and a drain of each of the compensation switches and a drain of a corresponding detection switch of the detection switches are electrically connected to a same sub-selection group of the sub-selection groups.

5. The display panel according to claim 2, wherein the touch signal selection circuit further comprises a compensation selector line, compensation switches, and a compensation signal line;
the compensation selector line comprises compensation selection lines; each of the compensation selection lines is electrically connected to fourth timing switches, and is electrically connected to gates of corresponding ones of the compensation switches through the fourth timing switches; the compensation signal line is electrically connected to sixth timing switches, and is electrically connected to sources of the compensation switches through the sixth timing switches; the compensation signal line is electrically connected to the timing selection circuit through the compensation switches; and gates of the sixth timing switches, gates of the fourth timing switches, and gates of the second timing switches receive the same timing signal;
each of the sub-pixel selection lines is electrically connected to third timing switches, and is electrically connected to gates of the multiple display switches through the third timing switches; the display signal lines are electrically connected to fifth timing switches, and are electrically connected to sources of corresponding ones of the display switches through the fifth timing switches; and gates of the fifth timing switches, gates of the third timing switches, and gates of the first timing switches receive the same timing signal;
the compensation switches and the display switches are multiplexing switches, and the sub-pixel selection lines and the compensation selection lines are electrically connected to gates of the multiplexing switches;
the timing selection circuit comprises sub-selection groups, each of which is electrically connected to a respective display data line of the display data lines and a respective touch signal line of the touch signal lines; and a drain of each of the compensation switches and a drain of a corresponding detection switch of the detection switches are electrically connected to a same sub-selection group of the sub-selection groups.

6. The display panel according to claim 5, further comprising touch driving units; wherein the touch driving units are electrically connected to the compensation selector line, the touch selector line and the compensation signal line;
each of the touch driving units comprises at least two sub-touch driving groups, and the at least two sub-touch driving groups are electrically connected to at least two adjacent touch signal lines of the touch signal lines, respectively; each of the at least two sub-touch driving groups comprises one of the fourth timing switches, one of the sixth timing switches, one of the detection switches and one of the display switches; and
the at least two sub-touch driving groups share a touch detection line of the touch detection lines, which is electrically connected to two of the detection switches;
the at least two sub-touch driving groups are electrically connected to at least two of the sub-touch selection lines respectively, and are electrically connected to at least two of the compensation selection lines respectively.

7. The display panel according to claim 5, further comprising display driving units; wherein the display driving units are electrically connected to the pixel selector line; each of the display driving units is electrically connected to one of the display signal lines;
each of the display driving units comprises at least two sub-display driving groups, each of which comprises at least one of the third timing switches and at least one of the fifth timing switches, and one of the display switches; the pixel selector line comprises at least two sub-pixel selection lines of the sub-pixel selection lines; the at least two sub-display driving groups are electrically connected to the at least two sub-pixel selection lines respectively;
the at least two sub-pixel selection lines are respectively electrically connected to at least two display switches of the display switches through at least two third timing switches of the third timing switches located in a same display driving unit of the display driving units; the display signal line branches into at least two display signal branches, and the at least two display signal branches are respectively electrically connected to the at least two display switches through at least two fifth timing switches of the fifth timing switches located in the same display driving unit, and are respectively electrically connected to at least two of the display data lines through the at least two display switches.

8. The display panel according to claim 7, wherein the pixel selector line comprises two sub-pixel selection lines; and the display driving unit comprises two third timing switches of the third timing switches, two fifth timing switches of the fifth timing switches, and two display switches of the display switches; and
the two sub-pixel selection lines are respectively electrically connected to the two display switches through the two third timing switches located in the same display driving unit; the display signal line branches into two display signal branches, and the two display signal branches are respectively electrically connected to the two display switches through the two fifth timing switches located in the same display driving unit, and are respectively electrically connected to two of the display data lines after passing through the two display switches.

9. The display panel according to claim 7, wherein the pixel selector line comprises three sub-pixel selection lines; and the display driving unit comprises three third timing switches of the third timing switches, three fifth timing switches of the fifth timing switches, and three display switches of the display switches; and
the three sub-pixel selection lines are respectively electrically connected to the three display switches through the three third timing switches located in the same display driving unit; the display signal line branches into three display signal branches, and the three display signal branches are respectively electrically connected to the three display switches through the three fifth timing switches located in the same display driving unit, and are respectively electrically connected to three of the display data lines after passing through the three display switches.

10. The display panel according to claim 7, wherein the pixel selector line comprises four sub-pixel selection lines; and the display driving unit comprises four third timing switches of the third timing switches, four fifth timing switches of the fifth timing switches, and four display switches of the display switches; and
the four sub-pixel selection lines are respectively electrically connected to the four display switches through the four third timing switches located in the same display driving unit; the display signal line branches into four display signal branches, and the four display signal branches are respectively electrically connected to the four display switches through the four fifth timing switches located in the same display driving unit, and are respectively electrically connected to four of the display data lines after passing through the four display switches.

11. The display panel according to claim 7, wherein the pixel selector line comprises five sub-pixel selection lines; and the display driving unit comprises five third timing switches of the third timing switches, five fifth timing switches of the fifth timing switches, and five display switches of the display switches;
the five sub-pixel selection lines are respectively electrically connected to the five display switches through the five third timing switches located in the same display driving unit; the display signal line branches into five display signal branches, and the five display signal branches are respectively electrically connected to the five display switches through the five fifth timing switches located in the same display driving unit, and are respectively electrically connected to five of the display data lines after passing through the five display switches.

12. The display panel according to claim 7, wherein the pixel selector line comprises six sub-pixel selection lines; and the display driving unit comprises six third timing switches of the third timing switches, six fifth timing switches of the fifth timing switches, and six display switches of the display switches; and
the six sub-pixel selection lines are respectively electrically connected to the six display switches through the six third timing switches located in the same display driving unit; the display signal line branches into six display signal branches, and the six display signal branches are respectively electrically connected to the six display switches through the six fifth timing switches located in the same display driving unit, and are respectively electrically connected to six of the display data lines through the six display switches.

13. The display panel according to claim 2, wherein the touch signal selection circuit further comprises precision switches;
each of the detection switches is connected in parallel with at least one of the precision switches; a gate of each precision switch of the precision switches and a gate of a corresponding detection switch of the detection switches that is connected in parallel with the each precision switch are electrically connected to a same sub-touch selection line of the sub-touch selection lines.

14. The display panel according to claim 1, further comprising a liquid crystal structure and a supplemental power supply;
wherein the liquid crystal structure comprises common electrodes, pixel electrodes, and a liquid crystal layer; the common electrodes and the pixel electrodes are at the same side of the liquid crystal layer; and the pixel electrodes are electrically connected to the display data lines, and the common electrodes are electrically connected to the touch signal lines; and
the supplemental power supply is electrically connected to the common electrodes and is configured to supply a supplemental voltage to the common electrodes during a period in which the display panel is in a display mode.

15. The display panel according to claim 14, wherein the supplemental power supply comprises a first supplemental power supply and a second supplemental power supply; and the first supplemental power supply and the second supplemental power supply are located at two sides of the liquid crystal structure respectively; and
a plurality of first sub-power supplies are provided in the first supplemental power supply, and a plurality of second sub-power supplies are provided in the second supplemental power supply; and each of the first sub-power supplies is correspondingly electrically connected to two of the second sub-power supplies and simultaneously electrically connected to 0 two of the common electrodes.

16. The display panel according to claim 1, further comprising a driving chip;
wherein the driving chip is configured to transmit at least a timing signal for driving a gate driving unit; and gates of the first timing switches and the second timing switches are configured to receive the timing signal.

17. A display device comprising the display panel according to claim 1.

18. A method for controlling the display panel according to claim 1, comprising:
when the display panel is in a display mode, the first timing switches are turned on and the second timing switches are turned off, according to timing signals transmitted by the timing selection lines; display signals transmitted by the display signal selection circuit are transmitted to the display data lines through the timing selection circuit; and
when the display panel is in a touch mode, the first timing switches are turned off and the second timing switches are turned on, according to the timing signals transmitted by the timing selection lines; touch signals transmitted by the touch signal selection circuit are transmitted to the touch signal lines through the timing selection circuit.

19. The method according to claim 18, wherein the touch signal selection circuit comprises a touch selector line, touch detection lines, and detection switches; and the display signal selection circuit comprises a pixel selector line, display signal lines, and display switches;
the touch selector line comprises sub-touch selection lines; each of the sub-touch selection lines is electrically connected to gates of multiple detection switches of the detection switches and is configured to turn on or turn off the multiple detection switches; the touch detection lines are electrically connected to the timing selection circuit through the detection switches; and the touch detection lines are electrically connected to the timing selection circuit through the detection switches when the detection switches are turned on; and
the pixel selector line comprises sub-pixel selection lines; each of the sub-pixel selection lines is electrically connected to gates of multiple display switches of the display switches and is configured to turn on or turn off the multiple display switches; and the display signal lines are electrically connected to the timing selection circuit through the display switches when the display switches are turned on.

20. The method according to claim 19, wherein each of the sub-touch selection lines is electrically connected to fourth timing switches, is electrically connected to gates of the multiple detection switches through the fourth timing switches, and is configured to turn on or turn off the multiple detection switches when the fourth timing switches are turned on; each of the touch detection line is electrically connected to sixth timing switches, and is electrically connected to sources of corresponding ones of the detection switches through the sixth timing switches; and gates of the sixth timing switches, gates of the fourth timing switches, and gates of the second timing switches receive the same timing signal;
each of the sub-pixel selection lines is electrically connected to third timing switches, is electrically connected to gates of the multiple display switches through the third timing switches, and is configured to turn on or turn off the multiple display switches when the third timing switches are turned on; each of the display signal line is electrically connected to fifth timing switches, and is electrically connected to sources of corresponding ones of the display switches through the fifth timing switches; and gates of the fifth timing switches, gates of the third timing switches, and gates of the first timing switches receive the same timing signal; and
the detection switches and the display switches are multiplexing switches, and the sub-pixel selection lines and the sub-touch selection lines are electrically connected to gates of the multiplexing switches, the sub-pixel selection lines are configured to turn on or turn off the multiplexing switches when the third timing switches and the fifth timing switches are turned on, and the sub-touch selection lines are configured to turn on or turn off the multiplexing switches when the fourth timing switches and the sixth timing switches are turned on.

21-24. (canceled)
